(19) United States
(12) Patent Application Publication
(10) Pub. No.: US 2024/0349743 A1
(43) Pub. Date: Oct. 24, 2024

(54) FRIED FOOD PRODUCTS AND METHODS OF MAKING SAME

(71) Applicant: JimmyAsh LLC, Bakersfield, CA (US)

(72) Inventors: Laurie J. Keeler, Bakersfield, CA (US); Jamshid Ashourian, Santa Monica, CA (US)

(21) Appl. No.: 18/640,288

(22) Filed: Apr. 19, 2024

Related U.S. Application Data
(60) Provisional application No. 63/497,244, filed on Apr. 20, 2023.
(60) Provisional application No. 63/559,097, filed on Feb. 28, 2024.

(51) Int. Cl. A23B 7/06; A23B 7/02; A23B 7/03; A23L 5/10; A23L 19/18; A23L 29/00

(52) U.S. Cl. CPC A23B 7/06; A23B 7/0205; A23B 7/03; A23L 5/11; A23L 19/18; A23L 29/06

(57) ABSTRACT

A process for preparing a food product comprises providing or receiving a plurality of food pieces of a food material having an initial moisture content, optionally enzyme treating the food pieces with an effective amount of at least one starch-degrading enzyme to provide enzyme-treated food pieces, optionally blanching the enzyme-treated food pieces to deactivate the starch-degrading enzyme to provide blanched food pieces, and reducing moisture of the food pieces, the enzyme-treated food pieces, or the blanched food pieces via air drying from the initial moisture content to reduced overall moisture content that is lower than the initial moisture content, to provide moisture-reduced food pieces.

### CROSS-REFERENCE TO RELATED APPLICATIONS

This application claims priority under 35 U.S.C. § 119 (c) to U.S. Provisional Application No. 63/497,244 filed on Apr. 20, 2023, entitled “FRIED FOOD PRODUCTS AND METHODS OF MAKING SAME,” and to U.S. Provisional Patent Application No. 63/559,097, filed on Feb. 28, 2024, entitled “FRIED FOOD PRODUCTS AND METHODS OF MAKING SAME,” the disclosures of which are incorporated herein by reference in their entireties.

### BACKGROUND

The present disclosure relates generally to fried food products, such as French fries, snack foods, or similar fried food products, and methods of making them. In some examples, the present disclosure relates to low-fat fried food products and the methods for producing them.

Fried food products, such as French fries, are typically made by frying cut or shaped food pieces in hot oil so that the moisture content of the cut or shaped food pieces is lowered. Conventionally, when the food pieces are larger in size, i.e., where the smallest dimension of the food piece is at least about 5 millimeters thick, such as with French fries, the food pieces are first subjected to par frying wherein the food pieces are fried in oil at a relatively low temperature, e.g., about 325° F. to about 365° F., to remove an initial amount of the moisture content, particularly from an outer region of the food pieces, and to cook the starch of the food pieces throughout the entire thickness from the outside through to the center. Then the food pieces can be allowed to cool (sometimes by refrigerating or freezing the food pieces in this intermediate state), followed by a second frying step at a higher temperature of from about 375 to about 400° F. for about 3 minutes to about 4 minutes, which acts to brown and crisp the outer region of the food pieces.

In other embodiments when the smallest dimension of the food pieces are thinner, such as with potato chips and other snack foods, the food pieces may only require a single frying step, e.g., frying the food pieces at a temperature of up to 465° F.

Frying in oil raises the fat content of the ultimate fried food pieces. In the case of French fries or other larger-sized food products, the final cooked food pieces can have a crispy outer region and a fluffy, moist inner region, which adds significantly to its organoleptic desirability. In the case of potato chips or other fried snack foods, the cooked food pieces can have a crispy texture throughout and less than 4% moisture in the finished and ready-to-cat product. Fried potato fries typically have a relatively high fat content of from about 10% to about 25% by weight, or higher, which is considered by some to be unhealthy, particularly if these fried food products are broadly substituted for low-fat foods and/or if consumption is substantial over time.

In addition, oil frying requires a relatively large amount of energy to raise the temperature of the oil up to the frying temperature and to maintain the oil at that temperature while the food pieces are cooking in the oil. It is also common to include one or more natural or synthetic additives or agents prior to or after par frying for color retention, texture, taste improvement, or both. In addition, pools of par frying oil that are used over and over are known to begin accumulating undesirable compounds and/or components, which can be unhealthy if consumed regularly or at relatively higher amounts over time. It is costly and difficult to filter and maintain oil quality over multiple uses, but it can be nearly impossible to rid par frying oils of all undesirable components that may accumulate over time. To address some of these concerns, efforts have been made to reduce the amount of fat in fried food products. Efforts have also been made to reduce the energy input required for cooking food pieces, while still producing a final food product that has a desirable flavor, crispness, and mouth feel. Despite many advances in the preparation of fried food products, there nevertheless remains a need for improvements to these products and to the processes for making them, for example to provide for improved crispness, mouth feel and flavor properties, reduction of fat content and overall improvement in nutritional profile, with less preparation time and/or requiring less energy input to produce, all resulting from processes that are feasible, efficient, manageable, and are practically and economically scalable for production at output levels necessary for product commercialization.

### SUMMARY

The present disclosure describes products that, although may be deep fried prior to consumptions, are not typically par fried (although par frying in some cases remains as an option) and the processes for preparing such food products. In an example, a process of producing such products comprises:
(a) providing a plurality of cut or shaped food pieces having an initial moisture content;
(b) optionally pretreating the food pieces with an effective amount of one or more starch-degrading enzymes or one or more cations or cation-producing compounds, or both one or more starch degrading enzymes and one or more cations or cation-producing compounds to provide pretreated food pieces;
(c) optionally blanching the pretreated food pieces to provide blanched food pieces; and
(d) reducing moisture of the blanched food pieces via air drying from the initial moisture content to an intermediate overall moisture content of from about 40% to about 95%, by weight, for example from about 50% to about 80% by weight.

The present disclosure also describes a food product comprising a plurality of food pieces having a reduced overall moisture content of from about 40% to about 95%, by weight, for example from about 50% to about 80%, by weight, wherein the moisture content of the food pieces was not reduced by par frying.

The present disclosure also describes a food product comprising a plurality of food pieces having a reduced overall moisture content of from about 50% to about 80%, or alternatively from 40% to 95%, by weight, wherein the food pieces are free or substantially free of deep fried oil.

### BRIEF DESCRIPTION OF THE FIGURES

The drawings illustrate generally, by way of example, but not by way of limitation, various embodiments discussed in the present document.

FIG. 1 is a flow diagram of an example process for making a food process, in accordance with the present disclosure.

FIG. 2 is a schematic diagram of a first example of a conventional system for processing a natural agricultural food material of an example geographical region to produce a fried or cooked food product for businesses in various municipalities in the geographical region.

FIG. 3 is a schematic diagram of a second example of a conventional system for processing the natural agricultural food material of geographical region to produce the fried or cooked food product for business in the various municipalities.

FIG. 4 is a schematic diagram of an example system for processing the natural agricultural food material of the geographical region to produce a food product via a moisture reduction process of to the present disclosure, and deliver the air-dried food product to businesses in the various municipalities, in accordance with the present disclosure.

FIG. 5 is a schematic diagram of another example system for processing the natural agricultural food material of the geographical region to produce the food product via the moisture reduction process of the present disclosure, and deliver the air-dried food product to business in the various municipalities, in accordance with the present disclosure.

### DETAILED DESCRIPTION

The following detailed description provides details of a process for preparing a food product that will eventually be fried to produce a fried food product, such as potato pieces that can subsequently be fried to produce French fries or snack food products such as potato chips and sticks. The description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range. The statement “about X to Y” has the same meaning as “about X to about Y,”” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1”” is equivalent to “0.0001.”

In the processes described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range, and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In a process according to the present disclosure, a plurality of cut or shaped food pieces of one or more food materials are provided. For example, the processes described herein are useful in preparing food pieces from any food material that can be prepared and fried or otherwise cooked for consumption including plant-based food materials such as one or more vegetable (including root vegetables), fruit, or plant-based meat material such as, but not limited to, plant-based chicken, plant-based turkey, plant-based beef, plant-based lamb, plant-based alligator, plant-based ostrich, or plant-based fish. In an example, the food pieces are made from the food material are processed for later frying to produce an oil-fried vegetable food product and/or an oil-fried fruit food product, such as fruits or vegetables that have a generally solid inner matrix that is exposed when cut or shaped and that can demonstrate fracturability when the food piece is bent. Examples of fruits or vegetables that can be prepared by the processes described herein include, but are not limited to: potato, sweet potato, yam, green bean, beet, pumpkin, squash, tomato, mushroom, zucchini, carrot, eggplant, okra, onion, parsnip, rutabaga, taro, yuca, cassava, apple, pear, banana, berries, pineapple, plantain, papaya, mango, grain, nut, legume, bean, and seed. In the case of plant-based meat, the plant-based meat material (e.g., plant-based chicken, plant-based turkey, plant-based beef, plant-based fish, etc.) can be shaped as nuggets, patties, stick shapes, and the like.

The processes described herein have been found to be particularly useful in preparing cut or shaped potato pieces wherein the food pieces will subsequently be fried in oil to produce a final fried potato product. For example, in the processes described herein are particularly for potato pieces of a size that is traditionally associated with French fries (e.g., potato pieces cut or shaped in a stick-like or cylindrical shape with a length that is substantially longer than a width and depth, and with a size in the smallest dimension of the potato piece that is at least about 5 mm (at least about 0.2 inches), for example about 6 mm (about ¼ inch), about 8 mm (about ⅜ inch), or about 10 mm (about 0.4 inch)). However, those having skill in the art will appreciate that the processes described herein can be used on food piece shapes other than fries (e.g., stick), including, but not limited to, potato chips (e.g., thinly sliced potato pieces having a thickness of from about 1.25 mm (about 0.05 inch) to about 5 mm (about 0.2 inch), such as about 1/16 inch (about 1.6 mm) or about ⅛ inch (about 3.2 mm)), waffle-cut fries, steak fries, wedge shapes, curly shaped (e.g., curly fries), slab shaped (e.g., potato slabs), or shaped food pieces such as patties (e.g., potato patties), hashed shaped (e.g., hash browns), or tot shaped (e.g., potato tots). Those having skill in the art will also appreciate that the processes described herein can be used food materials other than potatoes or other vegetable, but rather could be used for another type of food altogether.

In an example, the food pieces used in the processes described herein comprise a potato substrate, which can include farm-grown potatoes (e.g., raw potatoes) of any variety. Examples of potato varieties that can be prepared by the processes described herein include, but are not limited to: Bintje, Russet Burbank, Yukon Gold, Kennebec, Norchip, Atlantic, Shepody, Sebago, Red Pontiac, Red Warba, Irish Cobbler “BC”, Norgold Russet “BC”, Norland, White Rose, Superior, Centennial Russet, Keswick “NB 1”, Green Mountain, La Soda, Red La Rouge, Red Nordland, Red Bliss, Yellow Finnish, Ruby Crescent, Australian Crescent, Russian Blue, Peruvian Blue, Superior, Katahdin, Agria, Bannock Russet, Fontane, Innovator, Maris Piper, Marlen, Santana, and Victoria, and sweet potato varieties such as Beauregard, Jewel, Nemagold, Centennial, Excel, Regal, Southern Delite (Hernandez), Vardaman, Travis, White Delight, Sumor, Nancy Hall, Picadita, Campeon, Star Leaf/Boniato, Japanese, Chinese, and Okinawan Purple.

The food pieces have an initial moisture content. In an example, the initial moisture content is the amount of water, by weight, that the particular type of food that is cut or shaped to form the food pieces has naturally or typically. In an example, the food pieces have an initial moisture content of from about 55% to about 90%, by weight, for example from about 65% to about 85%, by weight, such as from about 75% to about 82% by weight, however those having skill in the art will appreciate that the initial moisture content can vary widely depending on many factors including, but not limited to, the amount of rainfall or other irrigation for the plants during growing, storage conditions for the raw food material and/or for the cut or shaped food pieces, and the specific variety of the raw food material. In an example, raw potato pieces typically have an initial moisture content of from about 75% to about 85%, by weight, such as from about 78% to about 82%. In an example, raw sweet potato pieces typically have an initial moisture content of from about 55% to about 80%, by weight, such as from about 65% to about 75%, by weight.

The processes of the present disclosure include preparing food pieces to reduce the moisture content from the initial moisture content to an intermediate overall moisture content to prepare the food pieces for a finishing cook, such as a final oil frying step. The final cooking step is not limited to frying in oil and will include any other methods including but not limited to microwave cooking, baking, air frying, in addition to frying or deep frying in oil. As will be appreciated by those having skill in the art, it can be desirable for French fries to have a relatively crispy outer region or crust and a moist and fluffy inner region. It can be desirable to have a final overall moisture content of from about 15% to about 45%, by weight, such as from about 35% to about 45%, by weight. However, if relatively thick potato pieces (e.g., potato pieces having a size in the smallest dimension that is at least about 5 mm (at least about 0.2 inches), for example at least about 8 mm (at least about ⅜ inch)) are to be fried in oil, then it is not possible to reduce the moisture content of the potato pieces from the initial moisture content of raw potato (which typically is from about 75% to about 85%) all the way down to such a final moisture content in a single frying step. As will be appreciated by those having skill in the art, if it is attempted to remove the moisture from French fry potato pieces all in one frying step, the higher temperature necessary to achieve a crispy outer crust tends to cause the crust to become overcooked or charred before the heat has adequately reached the interior of the potato piece to cook the starch in the inner region. In addition, the overcooked crust can tend to seal moisture into the inner region so that the inner region may be undercooked.

Because of this inability to fry raw potato pieces in a single frying step, it is common for French fries to be made by first partially frying the potato pieces (often referred to as “par frying”) in oil at a first frying temperature to an intermediate moisture content (for example, from about 60% to about 70%, by weight), which also typically cooks the starch of the potato pieces throughout the entire piece from the outside region to the center. Then, the par fried potato pieces can optionally be allowed to cool, followed frying the par fried potato pieces in a final frying step in oil at a second frying temperature that is higher than the first frying temperature, typically for a shorter period of time than the par frying step. The higher temperature of the final fry acts to rapidly drive moisture out of an outer region of the potato pieces without affecting the inner region, which crisps and browns the outer region but keeps the inner region fluffy and relatively moist. In an example, the first frying temperature of the oil for the par frying step is from about 300° F. (about 150° C.) to about 365° F. (about 185° C.) and the second frying temperature for the final frying step is higher than the first frying temperature of the par frying step and is from about 350° F. (about 175° C.) to about 400° F. (about 205° C.). The par frying step at the lower frying temperature reduces the moisture from the entire potato piece and acts to cook the inner region of the potato pieces as well as the outer crust region. The final frying step at the higher frying temperature acts to crisp the outer crust quickly without overcooking the inner region.

The processes of the present disclosure replace the conventional intermediate oil par frying step with an intermediate moisture reduction step that reduces the moisture of the food pieces from their initial moisture content to an intermediate overall moisture content of from about 40% to about 95%, by weight, such as from about 50% to about 80%, by weight. In some preferred embodiments, the moisture reduction step is primarily an air drying step. As used herein, the terms “air drying” or “air-based moisture reduction” refer to a process wherein the primary drying medium is air (e.g., a gaseous drying medium, and in particular air from the Earth's atmosphere). Any time the terms “air drying” or “air-based moisture reduction” are used, however, they could also be referring to other processes that involve moisture removal from food pieces primarily with a drying medium comprising air, whether that process is referred to as “air drying,” “air baking,” “air frying” or similar terms. In addition, any viable method of moisture reduction other than “air drying,” “air baking,” or “air frying” that is known to those of skill in the art or that is later discovered can be used in addition to or in place of air-based moisture reduction methods to achieve at least a portion of the moisture reduction with the same or similar moisture content results. These additional moisture reduction methods include, but are not limited to, microwave cooking, roasting, stir frying, baking, centrifuge cooking, centrifuge drying, vacuum drying, freeze drying, and combinations thereof. In addition, flash frying or deep frying may be used in addition to or in place of any of the foregoing methods.

In some examples, the moisture reduction process of the present disclosure removes moisture from the food pieces in such a way that the overall moisture content (e.g., the moisture content for the entire food piece) is from about 40% to about 95%, by weight, such as from about 50% to about 80% by weight, and also so that an outer region of the food piece is dryer than the food piece as a whole so that the outer region will have a texture that is similar to what results from conventional par frying. In some examples, the moisture reduction process of the present disclosure can also act to at least partially cook the food material (e.g., the starch for potato food pieces) throughout its thickness so that the food material is cooked not just at a surface region of the food pieces, but throughout or substantially throughout the food pieces. For example, when the food pieces comprise potato, the intermediate moisture reduction process of the present disclosure can be configured to sufficiently heat an inner region (e.g., at the center) of the potato pieces, e.g., by cooking the starch of the potato, and in particular by fully or nearly fully cooking the inner region of the food pieces. As used herein, the term “cooked,” when referring to the food material of the food pieces, refers to heating the food material to a specified temperature for a specified period of time that is sufficient to cause at least one component of the food material at a specific location within the food piece to undergo a desired chemical change, a desire physical change, or both a desired chemical and a desired physical change. For example, in the case of potato food pieces for preparing French fries, the potato piece is considered cooked throughout at least when the starch in the entire potato piece (e.g., the starch near the outer crust and the starch in the central inner region) has been heated to a sufficient temperature so that the starch granules gelatinize and the starch softens. “Cooking” the inner region may also include breaking down components of the cell walls within the inner region of the potato piece, such as pectin and other structural compounds, which can allow the potato to soften at the inner region.

The inventors have found that, surprisingly, it is possible to effectively and sufficiently reduce the moisture of the food pieces to a reduced overall moisture content and/or to cook the food material throughout the food pieces without par frying the food pieces in oil, such that the resulting food pieces will still be desirably crispy on the outside and fluffy on the inside when subjected to a final moisture removal and finishing step (e.g., final frying or final baking). The intermediate moisture reduction step of the present disclosure can be configured with specific parameters (e.g., one or more drying stages or zones each with a specified combination of air temperature, drying time, air velocity, and food piece vibration) that the inventors have found can achieve a desired level of moisture reduction and/or cooking of the food pieces, and in some examples, so that an outer crust of the food pieces is crispy and so that an inner region of the food pieces is cooked, fluffy, and moist. The inventors have also found that, surprisingly, by reducing moisture of the food pieces by the specified moisture reduction process of the present disclosure, the amount of time and energy required for a subsequent finishing step, such as a final frying of the food pieces, can be reduced substantially below that which is required for final frying after a conventional par frying step, e.g., by as much as 50% compared to frying after conventional par frying.

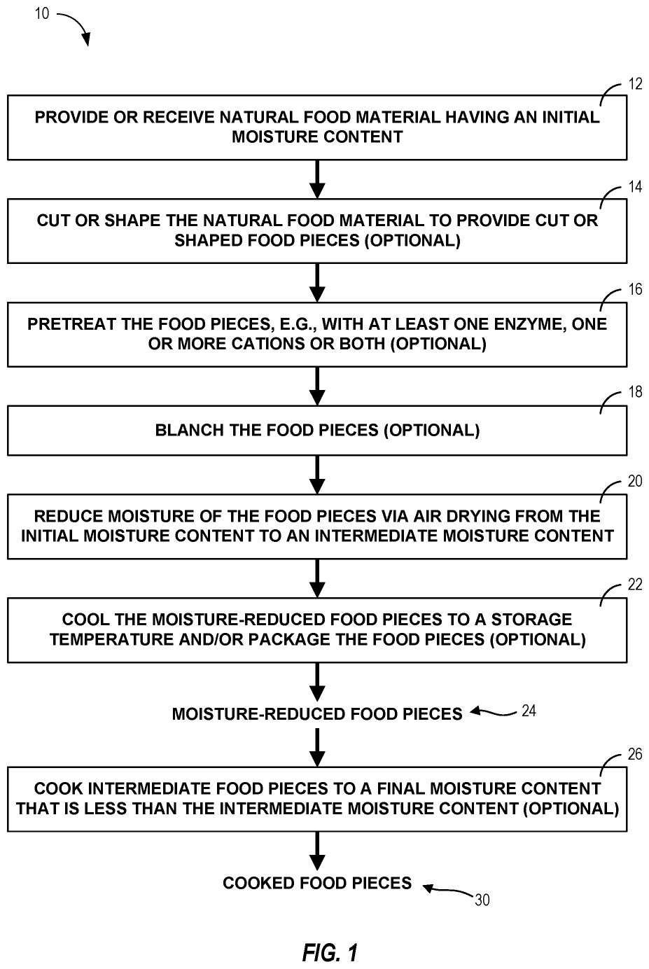

FIG. 1 is a flow diagram of an example process 10 for making a food product, comprising the steps of:
(a) providing or receiving natural food material having an initial moisture content;
(b) optionally, cutting or otherwise shaping the natural food material to provide a plurality of cut or shaped food pieces having the initial moisture content;
(c) optionally, pretreating the food pieces with an effective amount of at least one starch-degrading enzyme or one or more cations or one or more cation-producing compounds, or both to provide pretreated food pieces;
(d) optionally, blanching the pretreated food pieces to provide blanched food pieces; and
(e) reducing moisture of the blanched food pieces via air drying from the initial moisture content to an intermediate overall moisture content of from 40% to about 95%, by weight, such as from about 50% to about 80%, by weight, to provide moisture-reduced food pieces.

In some examples, the process 10 can further include one or both of the following steps:
(f) optionally, cooling the moisture-reduced food pieces to a storage temperature, to provide cooled food pieces; and
(g) cooking the cooled food pieces or the dried food pieces to a final moisture content that is less than the intermediate moisture content.

### Food Piece Preparation

In an example, the process 10 begins, at step 10, by providing or receiving a natural food material having an initial moisture content. The food material can include raw, natural forms of a food material, such as a raw plant material for vegetable or fruit food pieces. In an example the plant material can be in the form or substantially in the form from which the plant material is harvested. For example, for potato food products, the potato material that is provided or received in step 12 can be whole potatoes, e.g., as the whole root portion of the potato plant that is typically consumable by humans. For other types of plant food products, the raw food material can be in the form of other parts of a plant, such as the leaves, stalks, stems, shoots, roots, flowers (or portions of flows), or fruit of the plant.

Next, the process 10 can optionally include one or more preliminary preparation processes to prepare the natural food material for the rest of the process 10. For example, the natural food material can optionally be cleaned, scrubbed, and peeled (e.g., for potatoes or other food materials that may include a peel that is desired to be removed before cooking). In an example, the process 10 includes, at step 14, cutting or otherwise shaping the food material into a specified shape to provide food pieces. In examples where the final food product is to be French fries, cutting or shaping the natural food material (step 14) can include cutting the potatoes into a cylindrical or generally cylindrical shape having a size in the smallest dimension of from about 4 mm (about 0.15 inches) to about 15 mm (about 0.6 inch), for example from about 5 mm (about 0.2 inches) to about 10 mm (about 0.4 inches), such as about ⅛ inch (about 3 mm), about ¼ inch (about 6.3 mm) or about ⅜ inch (about 8 mm). In examples where the final food product is to be potato chips, cutting or shaping the natural food material (step 14) can include slicing the potatoes into thin slices having a thickness of from about 1 mm (about 0.04 inches) to about 5 mm (about 0.2 inch), for example from about 1.25 mm (about 0.05 inch) to about 4 mm (about 0.16 inch), such as about 1/16 inch (about 1.6 mm) or about ⅛ inch (about 3 mm).

In other examples, the food material as received can be the “food pieces” that will be processed by the remainder of the process 10. In other words, the full-sized natural pieces of the food material, as received, can be what is (optionally) pretreated and then dried by the air-based moisture reduction process of the present disclosure. In an example, the food pieces, whether cut or shaped or whole, can be washed with water or an aqueous solution to remove free starch.

### Pretreating

The process 10 can next include, at step 16, pretreating the food pieces, either the cut or shaped food pieces or the received whole food pieces. Pretreating the food pieces (step 16) can include one or more processes that prepare or modify one or more surfaces of the food pieces, which can provide for better effectivity of the remaining steps of the process 10. In an example, pretreating the food pieces (step 16) comprises exposing the food pieces to at least one enzyme, such as by submerging the food pieces in a solution comprising the enzyme, to provide enzyme-treated food pieces. Suitable enzymes for use in the enzyme treating step can include, but are not limited to, one or more of: an amylase (e.g., an alpha and/or beta amylase), a cellulase, an invertase, a pectinase, and an amyloglucosidase. In an example, an amylase is particularly preferred for food pieces, such as vegetable food pieces including potato pieces. Specific examples of enzymes are listed in U.S. Pat. Nos. 4,058,631; 5,312,631; and 7,056,544, each of which is incorporated by reference as if reproduced herein in their entireties. In an example, the one or more enzymes of the enzyme treating step degrade starch present on the surface of the food pieces, e.g., by cleaving various saccharides from the starches. Such degradation can also occur with starches present in an interior of the food pieces. In an example, the enzyme treatment includes exposing the food pieces to an enzyme solution wherein the one or more enzymes are present in the solution at a concentration of rom about 0.1% to about 5%, by weight, for example from about 0.5% to about 1.5%, by weight, such as about 0.9%, by weight, or about 1% by weight.

In an example, in addition to or in place of the enzyme treating, pretreating the food pieces (step 16) can also include exposing the food pieces to one or more cations. For example, if the enzyme treating comprises submerging the food pieces in a pretreatment solution, then the solution can also include the one or more cations in addition to or in place of the one or more enzymes. Or the pretreatment solution in which the food pieces are submerged can include only the one or more cations and no enzyme. In examples where the pretreatment (step 16) comprises exposure to both one or more enzymes and one or more cations, the one or more cations can be provided in a separate solution from the enzyme solution.

In an example, the pretreatment solution or solutions can comprise a cation-producing compound so that the food pieces are exposed to one or more cations in the solution. As used herein, the term “cation-producing compound” refers to compounds in which cations are produced in solution via dissociation of the cation with an anion, either at ambient temperatures or with the addition of heat. Examples of cation-producing compounds that can be used as part of the pretreating or as a separate treatment step include, but are not limited to: alkali metal salts, such as lithium, sodium and/or potassium salts; alkaline earth metal salts, such as magnesium and/or calcium salts; aluminum compounds; and group VA metal compounds, such as nitrogen, phosphorous and/or bismuth compounds (e.g., ammonium). More preferred from this set of compounds are calcium salts, magnesium salts, potassium salts, aluminum compounds and nitrogen compounds are particularly useful as cation treatment for the food pieces in the processes of the present description, with calcium salts being a preferred cation-producing compound. In an example, the one or more cations of a cation treatment are present in a solution to which the food pieces are exposed, with the one or more cations in the solution being at a concentration of from about 0.1% to about 5% by weight, such as from about 0.2% to about 2.5%, by weight, for example from about 0.3% to about 1%, by weight, such as about 0.5% to about 6%, by weight.

The pretreating of the food pieces (step 16) (e.g., with the one or more enzymes without the one or more cations, with the one or more cations or one or more cation-producing compounds without the one or more enzymes, or with both the one or more enzymes and the one or more cations or the one or more cation-producing compounds) can provide the food product formed by the food pieces with one or more improved properties compared to if the food pieces were not treated with the one or more enzymes or the one or more cations. As used herein, the term “improved property” refers to any property of the food product formed by the food pieces that is altered by the action of the one or more enzymes and/or the one or more cations relative to a comparable food product in which the food pieces are not treated with the one or more enzymes and/or the one or more cations. Improved properties can include, but are not limited to: reduced stickiness of the food pieces during later processing (particularly during moisture reduction air drying (step 20, described in more detail below); increased crispness (particularly of an outer crust of the food pieces) after final cooking; increased firmness of the raw and/or blanched food pieces; reduced browning from enzymatic and/or Maillard reactions; reduced acrylamide on the surfaces of the food pieces; improved color control (e.g., one or more of increased color brightening, increased color retention, increased color enhancement, or reduced color fading) without needing to use color-enhancing chemicals like sodium acid pyrophosphate, annatto color, and the like; increased stiffness; increased rugged or smooth appearance; improved flavor; and reduced fat content of the final food product. Many of these terms are defined and discussed more fully in U.S. Pat. No. 7,056,544, the entire disclosure of which is incorporated herein by reference. Other terms are defined in accordance with their customary meaning as they would be construed by a person having ordinary skill in the art.

In an example where the improved property is improved crispness or stiffness, those having skill in the art will appreciate that crispness and/or stiffness of the food pieces can be increased in a measured way, so that, for instance, if a certain crispness or a certain stiffness is desired to achieve certain processing goals or for producing a certain finished food product, crispness or stiffness can be controlled by varying the amount of exposure to the one or more enzymes and/or the one or more cations. Crispness can be modified, i.e., increased, by other means as well. For example, a coating, a batter, or both can be added to the food pieces to: increase or modify crispiness of the final food piece product. Adding a coating or batter can perform other functions in addition to or in place of modifying crispiness, such as one or more of: modifying flavor, controlling the amount of fat and oil that is absorbed into the food piece during frying, and extending the hold time (e.g., time that the food pieces remain crispy) after final frying or cooking. One or both of a coating or batter can be added, if desired, as part of the pretreatment (step 16), after the pretreatment (step 16) but before blanching (step 18, described below), after blanching but before the air-based moisture reduction (step 20, described below), during the air-based moisture reduction (step 20, described below), or after the air-based moisture reduce (step 20) either before or after one or more of the cooling and/or packaging (step 22, described below) and the final cooking if it is performed (step 26, described below).

The improved property can be determined by comparison of a food product prepared in accordance with the processes of the present disclosure versus a comparable food product prepared in accordance with conventional processes. Techniques for determining such improved properties achieved by use of the processes of the present disclosure are described herein. Organoleptic qualities may be evaluated using procedures well established in the food industry, and may include, for example, the use of a trained panel of sensory evaluators. Other processes can include texture analysis and comparisons such as those disclosed herein below.

In an example wherein the pretreatment (step 16) comprises exposure to the one or more enzymes, the one or more cations, or both, the food pieces can be exposed to the one or more enzymes and/or the one or more cations for a pretreatment time of from about 0.5 minutes to about 45 minutes, such as from about 0.5 minutes to about 15 minutes, for example from about 0.5 minutes to about 5 minutes, such as about 3 minutes.

### Blanching

Next, after enzyme treating the food pieces (with our without the inclusion of one or more cations or one or more cation-producing compounds) (step 16), the process 10 can include, at step 18, optionally blanching the pretreated food pieces to provide blanched food pieces. In an example, blanching the food pieces (step 18) achieves one or more of the following: (1) deactivation of one or more enzymes on the surfaces of the food pieces, and in particular deactivation of naturally-occurring enzymes on the surfaces of the food pieces and/or deactivation of the one or more enzymes applied during pretreating step 16; (2) gelatinization of at least a portion of the naturally-occurring starch on the surfaces of the food pieces; (3) removal of excess free sugars from the surfaces of the food pieces, which can reduce Maillard browning and the potential for formation of acrylamides during frying; and (4) improvement to texture and flavor of the food product that results from the food pieces. The blanching of the food pieces (step 18) can include lightly heating the food pieces, which can provide for a desired property of the final food product (such as a soft, fluffy interior for French fries).

In an example, blanching the enzyme-treated food pieces (step 18) comprises submerging the food pieces in an aqueous solution (often referred to as “blanch water,” “blanching water,” “blanching media,” or “blanching solution”). In an example, the aqueous solution comprises an effective amount of one or more cations (which can be the same cations as described above as part of the enzyme treating). In an example, the cations in the blanching solution are selected from the sodium cation (Na⁺) in sodium chloride (NaCl) or potassium chloride (KCl), the magnesium cation (Mg²⁺) in magnesium chloride (MgCl₂), and the calcium cation (Ca²⁺) in calcium chloride (CaCl₂)), however other cations can be used in the blanching solution. In an example, the concentration of the one or more cations or the one or more cation-producing compounds in the blanching solution is from about 0.5% to about 8%, by weight, such as from about 2% to about 5%, by weight, for example about 3% by weight. In an example, the blanching of the food pieces (step 18) is conducted at a temperature (e.g., with a temperature of the blanching solution) of from about 60° C. (about 140° F.) to about 120° C. (about 250° F.), for example from about 70° C. (about 160° F.) to about 100° C. (about 210° F.), such as about 80° C. (about 180° F.). In an example, the blanching of the enzyme-treated food pieces (step 18) is carried out for from about 15 seconds to about 10 minutes, for example from about 40 seconds to about 3 minutes, although the amount of time for the blanching can depend on the amount of blanching desired. The specific period of time and blanching temperature can be selected depending on the size of the food pieces and a desired throughput.

In another example, the blanching of the food pieces (step 18) can comprise exposing the food pieces to a blanching medium comprising oil or another fat, e.g., where the blanching medium is primarily oil or another fat-based compound, also referred to as “oil blanching”). In examples where the blanching (step 18) comprises oil blanching of the food pieces, the food pieces can be exposed to the blanching oil or fat (e.g., by submerging the food pieces in the oil or fat) at a specified temperature and for a specified period of time. Examples of temperatures for oil blanching the food pieces include, but are not limited to, a temperature of from about 100° F. (about 35° C.) to about 220° F. (about 105° C.), for example from about 130° F. (about 55° C.) to about 200° F. (about 95° C.). The blanching time for oil blanching the food pieces at these temperatures can be similar to the blanching time described above for water-based blanching media (e.g., from about 15 seconds to about 10 minutes, such as from about 40 seconds to about 3 minutes), although the amount of time for oil blanching will depend on the level of blanching desired and the temperature of the oil. In some examples, blanching can include exposing the food pieces to oil that is at a much higher temperature, e.g., at a temperature that might more conventionally be considered to be a “frying” temperature, such as 300° F. (about 150° C.) or more, for example from about 325° F. (about 160° C.) to about 375° F. (about 190° C.). In such high-temperature oil blanching, the amount of time that the food pieces are exposed to the hot oil would be much less, e.g., for from about only 2 seconds to about 15 seconds, for example from about 3 seconds to about 10 seconds or less.

In another example, the blanching of the food pieces (step 18) can comprise exposing the food pieces to steam (at ambient or higher pressures). Other known processes of blanching can also be sued, such as microwaving the food pieces, Ohmic heating of the food pieces, applying super-heated steam to the food pieces, infrared heating of the food pieces, and the like. As described in more detail below, other compounds can be added to the blanching media, such as oil or other fat, nutrients, flavoring, seasoning, or other additives.

In examples where the blanching (step 18) comprises immersing the food pieces in an aqueous blanching solution, the blanching can also include removing excess solution from the food pieces, such as by draining or conveying the blanched food pieces under an air curtain.

### Other Preliminary Steps

In some examples, nutrients or other additives can be added to the food pieces as part of the enzyme treating and/or cation treatment (step 16), after the enzyme treating and/or cation treatment (after step 16), as part of the blanching (step 18), or after the blanching (after step 18). For example, one or more nutrients or other additives can be infused into the solution of the enzyme treatment step. In an example, one or more vitamins or minerals can be added to the food pieces, including, but not limited to, Vitamin A, Vitamin, B6, Vitamin B12, Vitamin C, Vitamin D, Thiamin, Riboflavin, Niacin, Folic Acid, Phosphorous, Magnesium, Copper, Calcium, Zinc, Iron and the like. In other examples, the one or more nutrients or other additives can be included in the blanching step 18 (discussed below) or in a separate step in place of or in addition to their inclusion in the enzyme and/or cation treatment (step 16) or the blanching (step 18). In an example, adding the one or more nutrients or other additives can include spraying a compound including any desired nutrients (e.g., vitamins and/or minerals) over the food pieces prior to or after the air drying moisture reduction (step 20, described below), or prior to or after the final oil frying step. The inclusion of one or more nutrients can result in a food product that is nutritionally fortified and provides an opportunity to make a food product that is healthier.

In some examples, one or more flavors, one or more flavor enhancers, and/or seasoning can be added to the food pieces or the final food product, such as by spraying the food pieces with or soaking or steeping the food pieces in a solution that includes the one or more flavors, the one or more flavor enhancers, and/or the seasoning. In an example, the one or more flavors, the one or more flavor enhancers, and/or the seasoning can include, but is not limited to, one or more of: salt (NaCl), sugar, one or more herb extracts, one or more fruit extracts, one or more vegetable extracts, or a combination thereof. In an example, the one or more flavor enhancers can be included in the blanching solution or can be included in a separate solution that is part of separate step following or prior to the blanching (step 18) to infuse or otherwise add flavor to the food pieces. In an example, adding the one or more flavors includes soaking the food pieces in one or more concentrated flavor extracts that are either aqueous or otherwise. In another example, the food pieces be coated with chocolate, caramel, syrups, and coatings made from fruits or vegetables or any other similar covering, thereby creating other novel gourmet snacks.

In an example, a specified amount of digestible and/or synthetic fat, such as an oil or oil substitute, can be added to the food pieces prior to the air drying moisture reduction (step 20, described below) and/or prior to a final cook (step 26, described below). Adding the specified amount of digestible and/or synthetic fat can include any method of applying such a digestible and/or synthetic fat, including spraying on the food pieces, prior to, during, or after the air drying moisture reduction (step 20). In an example, the oil is a cooking oil not containing fatty acids, such as, but not limited to, canola oil, sunflower oil, or safflower oil. The oil can be applied to the food pieces by either spraying the oil onto the food pieces or by flash soaking the food pieces in the oil or by any other feasible method, such as applying to the blanching solution or spraying onto a conveyor belt or a tray before and/or after food pieces are placed onto such tray or belt. Although any food grade oil or oil substitute can be used, preferred oils are unrefined oils and those having a low smoke point, including, but not limited to: extra virgin olive oil, hemp seed oil, walnut oil, sesame oil, flaxseed oil, coconut oil, unrefined canola oil, semi-refined canola oil, unrefined peanut oil, safflower oil, sunflower oil, high-oleic sunflower oil, unrefined corn oil, soy oil, unrefined soy oil, unrefined sesame oil, avocado oil, animal based oils and fats (e.g., lard), flavor infused oils, emulsified vegetable shortening, and the like. In some examples, synthetic oils such as OLESTRA™ and the like can be included. Alternative oils that offer health benefits, such as SMART BALANCE™, ENOVA™ and the like, can be used either alone or in combination with other natural or synthetic oils such as those discussed above.

In particular, adding the specified amount of the digestible and/or synthetic fat may be desirable if the final cook of the food pieces (step 26, described below) is intended to be a baking step rather than a final frying step. As will be appreciated by those having skill in the art, food pieces of many types are more desirable from a flavor and organoleptic sense if they have at least some fat present in the final food pieces. However, if the final cooking step for the food pieces is a baking step, then there is not the addition of fat to the food pieces that occurs with deep frying. Therefore, adding a specified amount of a fat, such as oil, to the food pieces either before or after the moisture reduction step (described in more detail below) can be included in the process of the present disclosure. In an example where oil or fat is added to the food pieces, the amount of oil or fat that is added can be from about 0.5% to about 20% of the total weight of the food pieces, such as from about 1% to about 15%, for example from about 3% to about 12%, such as about 5% to about 10%.

If an oil or other fat is added to the food pieces before the moisture reducing air drying (step 20, described below), then the air drying configuration may need to be modified compared to a process of drying the same sized food pieces that do not include added oil or fat. This is so because the added oil or fat can result in a slowing down of the air drying process because the rate at which moisture leaves the food pieces is reduced. Without wishing to be bound by any theory, the inventors believe this is because the added oil or fat can act as a seal of some of the pores in the food pieces such that there is less area from which egressing moisture can escape. In an example, the addition of oil or other fat to the food pieces can require one or more of: an increase in the drying time of the air drying step, an increase in the air temperature during one or more stages of the air drying step, and an increase in the air flow velocity during one or more stages of the air drying step.

### Moisture Reducing Air Drying

Next, the process 10 includes, at step 20, reducing a moisture content of the food pieces from an initial moisture content (e.g., the natural moisture content of the food material that is received in step 12) to an intermediate overall moisture content to provide intermediate dried food pieces. As described above, the intermediate overall moisture content can be selected at a level so that the resulting intermediately dried food pieces are prepared for a final cook (step 26, described below), which can be, for example, by frying, baking, air frying, microwave cooking, and the like, to provide a finished cooked food product with desired properties. In an example, the overall moisture content to which the food pieces are dried after step 20 is from about 40% to about 95%, by weight, such as from about 50% to about 80%, by weight, while a final moisture content of the finished cooked food product after the final cook (step 26) is from about 15% to about 45%, such as from about 35 to about 45%, by weight. In an example, the moisture reducing air drying step 20 removes from about 20% to about 30%, by weight, or more of the initial moisture present in the food pieces to achieve the intermediate overall moisture content.

As is also mentioned above, in an example, the air-based moisture reduction step 20 is intended to replace conventional par frying. In other words, in an example, the moisture reduction by air drying of step 20 does not comprise par frying the food pieces and does not include exposure of the food pieces to heated oil for the purpose of cooking (oil may still be added for the purpose of adding a specified amount of the digestible and/or synthetic fat to the food pieces, however, as described above). Rather, the air drying (step 20) is configured so that the resulting intermediate dried food pieces are similar to conventionally par fried food pieces. For example, as discussed above, the air-based moisture reduction step 20 can be configured so that the food material of the food pieces is at least partially cooked throughout an entire thickness of the food pieces, i.e., both in a surface region of the food pieces near the outer surface of the food piece and in a center or inner region of the food piece. In the case of potato food pieces (e.g., for the purpose of making French fries), the air drying moisture reduction step 20 can cook the starch of the potato pieces all the way or substantially all the way to the center of the potato pieces.

Reducing the moisture content with the air-based moisture reduction step 20 can reduce the amount of fat present in the resulting moisture-reduced food pieces compared to conventionally oil fried food pieces. For example, French fried potato food pieces that have been par fried (but not finally fried) typically have a fat content of from about 3% to about 6%, by weight, due to the oil used in the par frying step. In contrast, comparable potato pieces where an initial moisture reduction is performed by the air-based moisture reduction step 20 of the present disclosure can have an intermediate fat content (i.e., before final frying or baking) of as low as 0% (when no oil is added during the intermediate preparation). Even if the food pieces are coated with some oil to enhance flavor (such as if the final cooking step 26 comprises baking instead of frying), the total fat content after the intermediate moisture reduction step 20 need not be more than about 1%, by weight, which is substantially less than the fat content of food pieces prepared by conventional par frying.

In examples wherein the final food product is to be potato chips or other snack foods, the air-based moisture reduction of the present disclosure (step 20) can entirely replace the step of conventionally frying the potato slices in oil. For example, the air-based moisture reduction step 20 of the present disclosure can be configured to reduce the moisture content of potato slices from their original moisture content (e.g., from about 75% to about 85%, by weight, such as from about 78% to about 82%) to a final moisture content corresponding to the desired crispiness for the potato chip (e.g., from about 1% to about 5%, by weight, such as from about 1.5% to about 3.5%, by weight). As with replacement of conventional par frying for French fries, replacing the oil frying of the potato chips or other snack foods with the air-based moisture reduction of the present disclosure (step 20) can substantially reduce the fat content of the resulting final product.

Also, the air-based moisture reduction of the present disclosure (step 20) allows for much more control over the total amount of oil or fat that will be present in the moisture-reduced food pieces compared to those prepared by conventional par frying and frying (for French fries) or by conventional deep frying (for potato chips and other food products that include only one frying step). Oil frying unavoidable adds fat content to the food pieces cooked by the oil frying. In addition, the amount of time that is required for a desired amount of moisture reduction via conventional oil par frying and deep frying often adds more fat content than is desired to add for a desired taste profile or a desired texture. In other words, while some fat content is desirable because it can add a pleasing taste, conventional oil frying often adds more than this amount of fat, which can have the undesirable results discussed above.

However, because the air-based moisture reduction process of the present disclosure (e.g., step 20 of the process 10) can replace all or a portion of one or more cooking steps that have conventionally been performed by frying in oil such that the amount of fat content added by oil frying can be substantially reduced or even eliminated. The air-based moisture reduction process of the present disclosure can, therefore, allow the amount of fat content that is added to be the amount that is desired for a desired taste or texture. The amount of fat content added can be anywhere from 0% added fat content (e.g., no oil added) up to any specified amount of fat content (e.g., percentage oil or other added fat) that is desired for a desired taste and/or texture. In addition, the specific fat-bearing material that is added to the food pieces can be selected for its effect on taste and/or texture rather than being limited to the fats that are conducive to the selected oil frying conditions (e.g., with a smoke point that is higher than the desired frying temperature and that will not break down during the desired time that the oil will be heated). Therefore, the air-based moisture reduction step of the present disclosure allows for selection and addition of any specified amount of vegetable based or animal based oil or fat to the food pieces. Also, the oil or fat can be added to the food pieces at any point in the process because they are being added for flavor or texture rather than for a specific cooking purpose.

In addition, because the air-based moisture reduction (step 20) can replace at least a portion of one or more conventional oil frying steps, if oil frying is still used (such as for the final cook step 26 for French fries, or for a portion of the moisture reduction for potato chips, for example to add a small amount of fat for flavor) the food pieces are fried in oil for substantially less time than in conventional methods. Not only does this reduce the amount of oil or fat that is absorbed into the food pieces during the frying compared to conventional oil frying, but it can also reduce the amount of or even eliminate other undesirable components. For example, as noted above, when the same pool of oil is used repeatedly over time, it can result in the accumulation of undesirable and potentially unhealthy compounds or components. Therefore, the replacement of one or more conventional frying steps with the air-based moisture reduction (step 20) of the present disclosure can substantially reduce the potential exposure of the food pieces to these undesirable compounds or components.

In an example, the air-based moisture reduction step 20 includes heating the food pieces in one or more dryers or ovens. Examples of dryers or ovens that can be used for the air drying step 20 include, but are not limited to: forced air convection ovens, fluidized bed dryers/ovens (such as a vibrating fluidized bed dryer/oven or a pulsed fluidized bed dryer/oven (e.g., Acro Pulse dryer)), impingement dryers/ovens, rotary dryers/ovens, rotary drum dryers/ovens, rotary spiral drum dryers/ovens, centrifuge dryers or ovens, centrifuge air dryers or overs, spin dryers, cylinder dryers, tray ovens, stationary dryers/ovens, spiral roasters/dryers (such as, for example, FMC Spiral Roto-Louvre Roaster/Dryers), microwave dryers/ovens, infrared dryers/ovens, super heat airless driers, vacuum driers, vacuum belt dryers and ohmic dryers, air frying devices, air ovens, or any similar drying/cooking apparatus. In some examples, the specific shape or form of the dryer or oven is not important so long as the dryer or oven can achieve the specified configuration to produce the desired air conditions to which the food pieces are exposed, as described below. In a preferred example, the air-based moisture reduction step 20 is performed in a fluidized bed air dryer that is configured for air drying of the food pieces that can replace conventional par frying of the food pieces.

In an example, the “configuring” of the air-based moisture reduction step 20 comprises selecting one or more parameters of the air drying, wherein the parameters can include a combination of one or more of the following: (1) total air drying time; (2) the number of drying stages; (3) the air drying time in each drying stage; (3) the air temperature in each drying stage; (4) the air flow velocity in each drying stage; and (5) agitation rate or force on the food pieces during each drying stage. As will be appreciated by a person of ordinary skill in the art, the specific values for each of these parameters will depend on many factors as well, including, but not limited to: the type of food pieces being dried (e.g., potato food pieces will have different parameters from sweet potato food pieces, which will have different parameters from green bean food pieces, etc.); the size and shape of food pieces being dried (e.g., traditional-sized square French fries (e.g., ⅜ inch (about 9.5 mm)) can have different parameters from smaller, shoestring sized French fries (e.g., ¼ inch (about 6.3 mm)); and a desired texture for the final cooked food product (e.g., the parameters if a very crispy outer crust on the final food product is desired may be different from the parameters if a more evenly fried final food product is desired).

Total drying time: In an example, the total air drying time for the air-based moisture reduction step 20 is from about 4 minutes to about 45 minutes, for example from about 5 minutes to about 35 minutes, such as from about 5 minutes to about 30 minutes, for example from about 5 minutes to about 25 minutes, such as from about 5 minutes to about 15 minutes, for example from about 5 minutes to about 10 minutes. The amount of time that the food pieces are subjected to the moisture reducing air drying step 20 can depend on the size of the food pieces, the desired intermediate moisture content, or the amount of oil or other fat present on the surfaces of the food pieces being dried. For example, so-called “shoestring” sized French fry food pieces (e.g., cut to a square cross section about ¼ inch (about 6.3 mm) in each direction) may require a shorter air drying time of from about 5 minutes to about 7 minutes, while thicker more traditional sized French fry food pieces (e.g., ⅜ inch (about 9.5 mm)) may require a longer air drying time of from about 8 minutes to about 15 minutes.

Number of Drying Stages: In an example, the air-based moisture reduction of the food pieces (step 20) comprises a plurality of drying stages. As used herein, the term “drying stage” refers to a specified portion of the air drying step wherein the food pieces are exposed to a specified set of conditions, and in particular to a specified air temperature at a specified air flow velocity. Each “drying stage” can comprise a different physical structure or portion of the drying equipment used for performing the moisture reducing air drying step 20. For example, if the air drying is performed in one or more air dryers, then in one example, each drying stage can be a different air dryer. In another example, each drying stage can be a specified chamber or section within a common air dryer. In another example, a first subset of one or more drying stages can each be a separate section or chamber in a first air dryer and a second subset of one or more drying stages can each be a separate section or chamber in a second air dryer. The drying stages can include one or any number of separate air dryers, such as one air dryer (which can be a single-zone air dryer or can be separated into two or more separate zones or stages), two separate air dyers (which can each be a single-zone air dryer or can be separated into two or more separate zones or stages), or three or more separate air dryers.

In an example, the air-based moisture reduction step 20 comprises two (2) or more separate drying stages, for example three (3) or more separate drying stages, such as four (4) or more separate drying stages, for example five (5) or more separate drying stages, such as six (6) or more separate drying stages.

Air Temperature: In an example, the air-based moisture reduction step 20 begins at a relatively high first air temperature (e.g., at a first of a plurality of drying stages) for a first time period, and the air temperature is gradually decreased (e.g., as the food pieces pass through subsequent drying stages). In an example, the first air temperature that the food pieces are exposed to in the first drying stage is from about 390° F. (about 199° C.) to about 415° F. (about 213° C.), for example from about 395° F. (about 202° C.) to about 410° C. (about 210° C.), such as from about 397° F. (about 203° C.) to about 405° F. (about 207° C.), for example about 400° F. (about 204° C.). The relatively high first air temperature for the first stage is selected to increase the temperature of the food pieces relatively rapidly. The rapid increase in temperature for the food pieces is somewhat mitigated by evaporative cooling of the food pieces as the largest proportional amount of moisture is removed during the first drying stage, which prevents or reducing the likelihood of browning during the first drying stage. In alternative embodiments, the air-based moisture reduction (step 20) can start at low or intermediate temperature and fluctuate at higher and/or lower temperatures during the different stages of the air moisture reduction step. In yet another embodiment, the entire air-based moisture reduction (step 20) can be conducted at one particular specified temperature.

After the first drying stage, the air temperature can be reduced in the second drying stage to a second air temperature that is slightly lower than the first air temperature, but that is still high enough to produce texture on the surfaces of the food pieces and to remove surface moisture from the food pieces, but not as high as the first air temperature in the first drying stage so as to avoid browning. In an example, the second air temperature that the food pieces are exposed to during the second drying stage is lower than the first air temperature of the first drying stage and is from about 385° F. (about 196° C.) to about 405° F. (about 207° C.), for example from about 390° F. (about 199° C.) to about 400° F. (about 204° C.), such as from about 395° F. (about 202° C.) to about 397° F. (about 203° C.).

In an example, after the first and second drying stages, the air temperature can be reduced again to a third air temperature that is lower than the second air temperature. In an example, the third air temperature is selected to avoid or reduce browning on the surfaces of the food pieces and to allow for moisture from a more inner region of the food pieces to be migrated out of the food pieces. In an example, the third air temperature for the third drying stage is lower than the second air temperature for the second drying stage and is from about 370° F. (about 188° C.) to about 390° F. (about 199° C.), for example from about 372° F. (about 189° C.) to about 385° F. (about 196° C.), such as from about 375° F. (about 190° C.) to about 380° F. (about 193° C.).

In an example, the air-based moisture reduction step 20 can include a fourth drying stage at a fourth air temperature that is lower than the third air temperature of the third drying stage. In an example, the fourth air temperature is selected for further migration of moisture from the inner region of the food pieces with little or no additional browning of the outer surfaces. The fourth air temperature can also allow for further setting of desired texture of the outer surfaces of the food pieces. In an example, the fourth air temperature for the fourth drying stage is lower than the third air temperature for the third drying stage and is from about 315° F. (about 157° C.) to about 360° F. (about 182° C.), for example from about 325° F. (about 163° C.) to about 340° F. (about 171° C.), such as from about 330° F. (about 166° C.) to about 335° F. (about 168° C.).

In an example where the air-based moisture reduction step 20 includes four drying stages, the four drying stages can all be different zones of the same dryer apparatus. For example, the four drying stages can be zones 1-4 of a four-zone fluidized bed air dryer, wherein a first zone is set at the first air temperature, a second zone is set at the second air temperature, a third zone is set at the third air temperature, and a fourth zone is set at the fourth air temperature.

In an example, the air-based moisture reduction step 20 can include additional drying stages beyond the fourth drying stage, such as an optional fifth drying stage. In an example with a fifth drying stage, the food pieces can be exposed to a fifth air temperature in the fifth drying stage that is less than the fourth air temperature. In an example, the fifth air temperature can be substantially lower than the fourth air temperature and drying in the fifth drying stage can be primarily to cool down the food pieces and to provide a small amount of additional drying with reduced or minimized acrylamide formation and/or browning on the surfaces of the food pieces. In an example, the fifth air temperature of the fifth drying stage is from about 240° F. (about 115° C.) to about 300° F. (about 149° C.), for example from about 245° F. (about 118° C.) to about 275° F. (135° C.), such as from about 250° F. (about 121° C.) to about 260° F. (about 127° C.). In an example, the air-based moisture reduction step 20 can include an optional sixth drying stage, which can include drying the food pieces with air at a sixth air temperature that is lower than the fourth air temperature of the fourth drying stage. In an example, the sixth air temperature can be the same as the fifth air temperature, described above.

Air Flow Velocity: During the air-based moisture reduction step 20, the food pieces are exposed to flowing air having the one or more air temperatures described above. In an example, this includes flowing hot air over and through the food pieces at one or more specified air flow velocities to draw moisture out of the food pieces and to produce texture on the surfaces of the food pieces. In an example, the air flow velocity of the air being passed over the food pieces can be changed for each of the drying stages, described above. For example, in the first drying stage with air at the first air temperature, the air can be flowed over the food pieces at a first air flow velocity. Similarly, in the second drying stage, air can be flowed over the food pieces at the second air temperature and at a second air flow velocity; in a third drying stage, air can be flowed over the food pieces at the third air temperature and at a third air flow velocity; in a fourth drying stage, air can be flowed over the food pieces at the fourth air temperature and at a fourth air flow velocity; and so on.

In an example, the air flow velocities in the different drying stages can be similar to the air temperatures, e.g., with the air flow velocity starting at a relatively high velocity for the first drying stage, and then gradually being reduced in one or more subsequent drying stages (e.g., in the second drying stage, third drying stage, fourth drying stage, and so on). In an example, during the air-based moisture reduction step 20, the food pieces are exposed to air at an air flow velocity of from about 200 feet per minute to about 15,000 feet per minute. In the first air-based moisture reduction stage or stages, while the food pieces are still totally or somewhat wet, the food pieces can be subjected to air pressure blowing from any or all directions or any combination thereof to prevent clumping and achieve uniform or substantially drying of the food pieces.

In an example, the air-based moisture reduction step 20 begins at a relatively high first air flow velocity (e.g., at a first of a plurality of drying stages) for a first time period, and the air flow velocity is gradually decreased (e.g., as the food pieces pass through subsequent drying stages). In an example, the air flow velocity and the air temperature work together to provide the desired effect for each drying stage of the moisture reducing air drying process.

In an example, a first air flow velocity that the food pieces are exposed to in the first drying stage is from about 12,750 feet per minute (ft/min) to about 15,000 ft/min, for example from about 13,500 ft/min to about 14,500 ft/min, such as about 14,250 ft/min. The high first air flow velocity, along with the high first air temperature, act to increase the temperature of the food pieces relatively rapidly. As described above, the rapid increase in temperature for the food pieces is somewhat mitigated by evaporative cooling of the food pieces as the largest proportional amount of moisture is removed during the first drying stage, which prevents or reducing the likelihood of browning during the first drying stage.

After the first drying stage, the air flow velocity can be reduced in the second drying stage to a second air flow velocity that is slightly lower than the first air flow velocity, but that is still high enough to produce texture on the surfaces of the food pieces and to remove surface moisture from the food pieces, but not as high as the first air flow velocity in the first drying stage so as to avoid browning. In an example, the second air flow velocity that the food pieces are exposed to during the second drying stage is lower than the first air flow velocity of the first drying stage and is from about 11,250 ft/min to about 13,500 ft/min, for example from about 12,000 ft/min to about 13,250 ft/min, such as about 12,750 ft/min.

In an example, after the first and second drying stages, the air flow velocity can be reduced again to a third air flow velocity that is lower than the second air flow velocity. In an example, the third air flow velocity is selected to avoid or reduce browning on the surfaces of the food pieces and to allow for moisture from a more inner region of the food pieces to be migrated out of the food pieces. In an example, the third air flow velocity for the third drying stage is lower than the second air flow velocity for the second drying stage and is from about 9,750 ft/min to about 12,000 ft/min, for example from about 10,500 ft/min to about 11,650 ft/min, such as about 11,250 ft/min.

In an example, the air-based moisture reduction step 20 can include a fourth drying stage with a fourth air flow velocity that is lower than the third air flow velocity of the third drying stage. In an example, the fourth air flow velocity is selected for further migration of moisture from the inner region of the food pieces with little or no additional browning of the outer surfaces. The fourth air flow velocity can also allow for further setting of desired texture of the outer surfaces of the food pieces. In an example, the fourth air flow velocity for the fourth drying stage is lower than the third air flow velocity for the third drying stage and is from about 8,250 ft/min to about 10,5000 ft/min, for example from about 9,000 ft/min to about 10,200 ft/min, such as about 9,750 ft/min.

As described above, in an example the air-based moisture reduction step 20 can include four drying stages that are each a different zone of the same dryer apparatus. For example, the four drying stages can be zones 1-4 of a four-zone fluidized bed air dryer, wherein a first zone is set at the first air flow velocity, a second zone is set at the second air flow velocity, a third zone is set at the third air flow velocity, and a fourth zone is set at the fourth air flow velocity.

In an example, the air-based moisture reduction step 20 can include additional drying stages beyond the fourth drying stage, such as an optional fifth drying stage. In an example with a fifth drying stage, the food pieces can be exposed to air flowing at a fifth air flow velocity in the fifth drying stage that is less than the fourth air flow velocity. In an example, the fifth air flow velocity can be substantially lower than the fourth air flow velocity and drying in the fifth drying stage can be primarily to cool down the food pieces and to provide a small amount of additional drying with reduced or minimized acrylamide formation and/or browning on the surfaces of the food pieces. In an example, the fifth air flow velocity of the fifth drying stage is from about 750 ft/min to about 3,750 ft/min, for example from about 1,000 ft/min to about 2,500 ft/min, such as about 1,500 ft/min. In an example, the air-based moisture reduction step 20 can include an optional sixth drying stage, which can include drying the food pieces with air at a sixth air flow velocity that is lower than the fourth air temperature of the fourth drying stage. In an example, the sixth air flow velocity can be the same as the fifth air flow velocity, described above.

Agitation: In an example, the air drying apparatus (e.g., the air dryer, such as a fluidized bed air dryer) can be configured to agitate the food pieces during the air-based moisture reduction step 20. Agitating the food pieces can be performed to ensure that the food pieces do not stick together during the air-based moisture reduction step 20 and/or to ensure relatively even distribution of air flowing over the food pieces during the air-based moisture reduction step 20. Therefore, “agitating” as used herein, can refer to sufficient agitation force to keep the food pieces moving relative to one another, e.g., so that the food pieces do not stick together, but not so large that the food pieces are broken (or so that only a small percentage of the food pieces will be broken by the agitation). In an example, agitating the food pieces can include vibrating the food pieces, e.g., in a vibratory tray or belt within the air drying apparatus. The agitation can also include exposing the food pieces to air pressure flowing in multiple directions, which can be applied in place of or in addition to vibration of the food pieces. In an example, the force at which the food pieces are vibrated or otherwise agitated can be adjusted during one or more of the drying stages. For example, during early drying stages (e.g., at the relatively high first air temperature and/or at the relatively high first air flow velocity, the relatively high second air temperature and/or at the relatively high second air flow velocity, the third air temperature and/or at the third air flow velocity, the fourth air temperature and/or at the fourth air flow velocity), the food pieces can be vibrated at or near the maximum force at which the drying apparatus can be vibrated. Then, at later drying stages (e.g., in a fifth and/or sixth drying stage, if present in the air drying process), the food pieces can be vibrated at a lower force so as to avoid bending or breaking of the food pieces (which may have become softer after the initial air drying stages).

### Optional Cooling (Freezing or Refrigeration) and Packaging

After the air-based moisture reduction step 20, the process 10 can include, at step 22, optionally cooling and/or packaging the dried food pieces to a storage temperature to provide cooled food pieces.

In an example, the storage temperature is such that the cooled food pieces can be stored for a prolonged period of time without spoiling before a final cooking step (step 26, discussed below). For example, the dried food pieces can be frozen for storage and transported to another location, e.g., where the final cooking step 26 (described below) can be performed. Packaging of the food pieces can include placing the food pieces in packaging that can minimize or prevent exposure of the food pieces to air during the time that the food pieces are being stored or transported.

In an example, the cooling of step 22 comprises freezing the dried food pieces at a temperature below the freezing temperature of water (e.g., below 32° F., 0° C.), for example at a freezing temperature of from about −20° F. (about −29° C.) to about 0° F. (about-18° C.). In other examples, cooling the dried food pieces can comprise refrigerating the dried food pieces to a temperature of from about 32° F. (about 0° C.) to about 40° F. (about 4° C.).

In examples where the food pieces are cooled to a freezing temperature, the food pieces can be frozen by individual quick freezing (IQF), such as with a tunnel freezer or a spiral freezer. However, other freezing methods can be used to cool the food pieces to the freezing temperature.

As discussed in more detail below, the process 10 (and in particular, the moisture reduction step 20, sometimes referred to as the “air-based moisture reduction step 20”) produces moisture-reduced food pieces 24 (which may also be referred to as “air dried food pieces 24”) that have a specified moisture content (e.g., of from about 50%-80% by weight when the final food product is to be French fries, or from about 1% to about 3.5%, by weight, when the final food product is to be potato chips). The term “moisture-reduced food pieces 24” can refer either to the food pieces that result immediately after the air-based moisture reduction step 20 or to the food pieces after cooling and/or packaging (e.g., after step 22).

In examples where the process 10 is for making French fries that have conventionally been par fried and then subject to a final fry, the moisture-reduced food pieces 24 can subsequently be subjected to a final cook (step 26, described below). In such an example, the moisture reduced food pieces 24 may also be referred to as “intermediate food pieces 24.” However, in other examples, such as with potato chips or other snack foods, the moisture reduction step 20 can be the “final” cooking step to which the food pieces are subjected, such that the moisture reduced food pieces 24 that result from the air-based moisture reduction step 20 and/or from the optional cooling and/or packaging step 22 are the final product and the final cook (step 26, described below) can be omitted.

The food pieces of the present invention may be frozen prior to final cooking step or may be preserved or packaged aseptically or in any other viable manner that will extend their shelf life or preserve them until the final cooking step before consumption or distribution that may include refrigerated transportation, deep frying, air frying, microwave cooking, baking, grilling, etc.

### Final Cook (e.g., Frying or Baking)

After the air-based moisture reduction step 20, and in some examples after the optional cooling (e.g., freezing) and/or packaging of the moisture-reduced food pieces (step 22), the process 10 can include, at step 26, cooking the intermediate food pieces 24 to further reduce the moisture content to provide cooked food pieces 30 having a final moisture content. In an example, the final moisture content of the cooked food pieces 30 is from about 15% to about 45%, by weight, such as from about 35 to about 45%, by weight. Methods for the final cooking (step 26) can include, but are not limited to, oil frying the intermediate food pieces 24 (e.g., immersing the intermediate food pieces 24 in hot oil so that oil can replace moisture in the intermediate food pieces 24 to arrive at the final moisture content for the cooked food pieces 30), baking the intermediate food pieces 24 (e.g., placing the intermediate food pieces 24 in an oven, such as a conventional oven or a microwave oven) that raises the temperature of the intermediate food pieces to drive additional moisture out of the food pieces to achieve the final moisture content of the cooked food pieces 30), a second air drying step, or air frying. In an example, the final cooking step 26 can include reducing moisture primarily at an outer region (e.g., an outer crust) of the intermediate food pieces 24 to provide a crispy outer region, while moisture reduction of the inner region of the cooked food pieces 30 remains relatively unchanged compared to that of the intermediate food pieces 24. This aspect of the process 10 can be particularly desirable when the food material is potato and the cooked food pieces 24 that are desired are French fries.

The final cooking step 26 can be performed by the same party that performed the other steps of the process 10 described herein (e.g., the same party can perform the steps of providing or receiving the food material (step 12), cutting or shaping the food pieces (step 14), pretreating the food pieces (step 16), blanching the food pieces (step 18), performing the air-based moisture reduction (20), optionally cooling (freezing) and/or packaging the dried food pieces (step 22), and the final cooking (step 26)). Alternatively, the final cooking (step 26) can be performed by a different party (e.g., a first party, such as a centralized food producer, can perform the steps of providing or receiving the food material (step 12), cutting or shaping the food pieces (step 14), pretreating (step 16), blanching (step 18), air-based moisture reduction (step 20), and optionally cooling and/or packaging (step 22), and the final cooking (step 26) can be performed by a second party, e.g., an intermediate factory, a restaurant, or an end consumer, that is a customer of the centralized food product producer).

In examples where the final cooking step 26 comprises oil frying, the frying can include cooking the intermediate food pieces 24 in an oil at a specified frying temperature configured for the particular type of food pieces being cooked. For example, for potato food pieces (e.g., French fries), the frying temperature for the final cooking step 26 can be from about 325° F. (about 163° C.) to about 425° F. (about 218° C.), such as from about 350° F. (about 176° C.) to about 400° F. (about 204° C.), for example from about 365° F. (about 185° C.) to about 385° F. (about 196° C.). Types of oil that can be used for the final frying step 26 can include oils that have a relatively high smoke point, such as, but not limited to, sunflower oil, canola oil, peanut oil, vegetable oil, corn oil, or safflower oil.

The inventors have found that, surprisingly, the time required for the final cooking step 26 when initial drying is achieved via the air-based moisture reduction step 20 is reduced compared to food pieces wherein conventional par frying is the initial moisture reduction step. For example, in a comparative process wherein potato food pieces are first par fried in oil at a temperature of 350° F. for about 3 minutes, the final frying step requires from about 3 to about 5 minutes frying in oil at about 375° F. to achieve a specified outer crispness and inner fluffiness. When the process 10 of the present disclosure (e.g., with the air-based moisture reduction step 20 under the conditions specified herein being performed in place of conventional par frying), a comparable outer crispness and inner fluffiness can be achieved with the final frying step 26 only requiring a frying time of about 90 seconds in 375° F. oil. In other words, the inventors have found that the time for the final frying step 26 can be 50% less than the final frying after conventional par frying moisture removal. The reduction in frying time for the final frying step 26 results in a substantial reduction in the energy required to prepare the final cooked food pieces 30 relative to comparable food pieces produced via conventional par frying methods. This substantial reduction in final frying time can be particularly attractive to restaurants because of the substantial reduction in preparation time for French fries compared to those prepared by conventional par frying.

In examples where the final cooking step 26 comprises baking, the baking can include heating the dried food pieces or the dried and cooled food pieces in an oven set at from about 350° F. (about 176° C.) to about 425° F. (about 218° C.).

The reduced frying or other cooking time can result in less acrylamide than food pieces prepared by conventional frying. For example, because the air-based moisture reduction of the present disclosure can replace conventional oil par frying, in an example, French fries that are made by a process that includes the air-based moisture reduction can have an acrylamide content before the final frying (or other cooking method) that is 500 parts per billion (ppb) or less, for example 400 ppb or less of acrylamide, 350 ppb or less, 300 ppb or less, 250 ppb or less, 225 ppb or less, 200 ppb or less, 175 ppb or less, 150 ppb or less, 125 ppb or less, 100 ppb or less, 90 ppb or less, 80 ppb or less, 75 ppb or less, 70 ppb or less, 60 ppb or less, 50 ppb or less, 40 ppb or less, 30 ppb or less, 25 ppb or less, 20 ppb or less, 15 ppb or less, 10 ppb or less, or even 5 ppb or less. And because intermediate French fries (e.g., wherein the air-based moisture reduction replaced conventional par frying) have lower acrylamide and because the final cooking step can be shorter than when conventional oil par frying is used, even for French fries that are cooked by a final oil frying step can have an acrylamide content for the fully cooked French fries that is low, such as 750 ppb or less, 700 ppb or less, 650 ppb or less, 600 ppb or less, 550 ppb or less, 500 ppb or less, 450 ppb or less, 400 ppb or less, 350 ppb or less, 300 ppb or less, 275 ppb or less, 250 ppb or less, 225 ppb or less, 200 ppb or less, 190 ppb or less, 180 ppb or less, 175 ppb or less, 170 ppb or less, 160 ppb or less, 150 ppb or less, 140 ppb or less, 130 ppb or less, 125 ppb or less, 120 ppb or less, 110 ppb or less, 100 ppb or less, 90 ppb or less, 80 ppb or less, 75 ppb or less, 70 ppb or less, 60 ppb or less, or 50 ppb or less. In some examples, both the intermediately air-dried French fry pieces and the fully cooked French fries have no acrylamide or substantially no acrylamide. These same acrylamide amounts may also be present for food products other than French fries, including other potato-based products (such as hashbrowns, potato chips, or potato sticks) or other food products or snack foods.

In some examples, the method can also include applying one or more additives as a coating or treatment to the food pieces that reduce the amount of acrylamide in the final cooked food products. Examples of acrylamide-reducing additives that can be used include, but are not limited to, one or more enzymes that act on acrylamide or precursor compounds that are converted to acrylamide by cooking processes such as oil frying, and/or ingredients that can reduce or prevent the formation of acrylamide, such as, but not limited to, acidic agents for example citric acid or rosemary extract.

### Integrated System for Efficient Food Product Production

The air-based moisture reduction step 20 of the process 10 described above, and the resulting effect it can have on the final cooking 30 of the moisture-reduced food pieces 24 to provide the final cooked food pieces 30 (e.g., reduction in oil frying time for the final frying step 26 when the moisture-reduced food pieces 24 are initially dried via the moisture reduction step 20 of the present disclosure) can allow for modifications of “typical” systems for the production of the types of food products described herein. Specifically, as described in more detail below, the novel and inventive moisture reduction step 20 of the present disclosure can allow for one or more centralized production facilities that receive the raw or natural food material (e.g., plant material, such as whole potatoes for potato food products, or other plant materials for food products made from other plant materials), perform any necessary preparation or pretreatment of the raw food material, performs the moisture reduction step 20, and cools and/or packages the dried food pieces that result from the moisture reduction step 20 (e.g., the moisture-reduced food pieces 24, which may be “intermediate” food pieces, such as intermediate French fry food pieces that are similar to conventionally par fried French fries, or may be the final food pieces, such as potato chips or other snack foods). The one or more centralized production facilities can be located in close proximity to the farms where the plants that produce the natural food material are grown (e.g., potato farms), for example by being located in a geographic region that is particularly suited for that particular plant or plants (e.g., because of climate, weather, soil, and other agricultural considerations). The centralized production facility can then ship the moisture-reduced food pieces 24 to another location. For example, if the moisture-reduced food pieces 24 are the final food product, such as for potato chips or other snack foods, the moisture-reduced food pieces 24 can be seasoned and packaged at the centralized production facility and shipped to businesses within municipalities from which the end user customers can purchase the moisture-reduced food pieces 24 (such as grocery stores 58 or restaurants 60, as described in more detail below). In other examples wherein the moisture-reduced food pieces 24 are intermediately cooked French fries (e.g., air dried equivalent to conventional oil par fried), then the intermediately cooked French fries can be shipped to another production facility for further processing of the intermediate moisture-reduced food pieces 24 (such as a facility that seasons various end products or adds additional flavoring, oil, or other components, or an additional cook step such as a partial oil fry step) before shipping to the businesses 58, 60 for sale to end user customers, or the moisture-reduced food pieces 24 can be cooled or frozen and shipped directly to businesses 58, 60. The moisture-reduced food pieces 24 can then be cooked by either the end user customer themselves (e.g., if the moisture-reduced dried food pieces 24 are shipped to a grocery store 58 where the end user customer purchases them and performs the final cooking step 26 at home, such as by pan frying or baking the moisture-reduced dried food pieces 24), or by a service provider that cooks the moisture-reduced food pieces 24 for the end user (e.g., when the end user is a customer at a restaurant 60, in which case the restaurant 60 performs the final fry of the cooking step 26 for the customer).

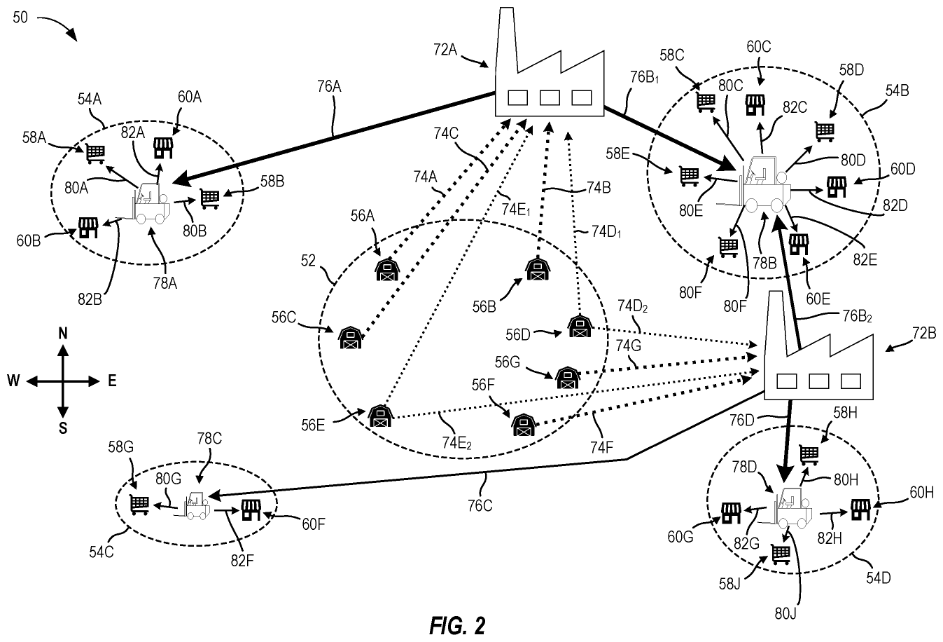

The advantages of such a production scheme are described with respect to FIGS. 2-5, which provide examples of food piece production and logistics systems 50, 70, 100, and 120 for producing a type of food product that has conventionally been prepared by frying-such as French fried potatoes that have conventionally been prepared by receiving potatoes shipped from various farms around the country, cutting or shaping the potatoes into a cylindrical or substantially cylindrical French fry shape, par frying the cut potato pieces, and subsequently performing a final fry of the par fried food pieces; or potato chips or other snack foods that conventionally have been prepared by receiving potatoes shipped from various farms around the country, slicing the potatoes into thin chip-like pieces, and frying the sliced potatoes in oil.

Each of the systems 50, 70, 100, 102 are alternative configurations for supplying the food product (e.g., intermediately dried and cooked French fries, or final potato chips) to the same geographical area, such as within a country or region of a country. The example geographical area of FIGS. 2-5 includes various local regions 52, 54A, 54B, 54C, and 54D. Each local region 52, 54A, 54B, 54C, 54D corresponds to a specified area of the overall geographical area (represented conceptually by the dashed ovals surrounding each local region 52, 54A, 54B, 54C, 54D). In an example, each local region 52, 54A, 54B, 54C, and 54D is located some distance away from the other local regions such that any material from one local region generally must be shipped or otherwise transported to any other local region, such as via freight shipping (e.g., tractor trailer shipping) or shipping via train. This shipping is represented conceptually by the various arrowed lines in FIGS. 2-5, which are described in more detail below.

The local region 52 is representative of an agricultural region where the raw food material (e.g., potatoes) is a major crop, which could be because the overall climate within the local region 52 is particularly conducive to growing the raw food material. For this reason, the local region 52 may also be referred to as “the agricultural region 52” for the raw food material. The plurality of local regions 54A, 54B, 54C, and 54D are representative of various regions in the geographical area where the population density is higher, meaning that there are more potential end-user customers for the food product. For example, each local region 54A, 54B, 54C, and 54D can correspond to a town, a city, or a metropolitan area within the geographic area, and therefore may each be referred to generically as “municipality 54” or collectively as “municipalities 54.” The size of each oval for the municipalities 54 roughly correspond to the population size for each municipality 54. For example, the municipality 54B can correspond to a relatively large metropolitan area (so that it may also be referred to as “the metropolitan area 54B”) with the largest population of the four local regions 54 shown in FIGS. 2-5 such that the metropolitan area 54B has the largest oval. The municipality 54C can correspond to a relatively small town or rural area (so that it may also be referred to as “the town 54C”) with the smallest population of the four local regions 54 shown in FIGS. 2-5 such that the town 54C has the smallest oval. And the municipalities 54A and 54D can correspond to medium-sized cities (so that they may also be referred to as “the city 54A” and “the city 54D”) with roughly the same population as one another, which is somewhere between the large population of the metropolitan area 54B and the small population of the town 54C such that the ovals representing the cities 54A and 54D are smaller than the oval for the metropolitan area 54B and larger than the oval for the town 54C.

The agricultural region 52 can include a plurality of farms 56A, 56B, 56C, 56D, 56E, and 56F (also referred to generically as “farm 56” or collectively as “farms 56”) that each grow the raw food material (e.g., potatoes) as at least one of its crops. Each of the municipalities 54 can include one or more businesses from which people in that particular local region 54 can purchase the produced food product. In FIGS. 2-5, these businesses are depicted as a plurality of grocery stores 58A-58J (also referred to generically as “grocery store 58” or collectively as “grocery stores”) where residents or visitors within the municipalities 54 can purchase the food product for cooking and/or consuming in their own homes, and a plurality of restaurants 60A-60H (also referred to generically as “restaurant 60” or collectively as “restaurants 60”) wherein residents or visitors within the municipalities 54 can order the food product as part of a meal or snack prepared by one of the restaurants 60. Those having skill in the art will appreciate that the systems 50, 70, 100, and 120 of FIGS. 2-5 are simplified versions of real-world geographical areas and local regions, and that in reality businesses that may receive food product may include many other types of businesses besides grocery stores and restaurants (such as convenience stores, event venues such as sports arenas or concert venues, food trucks, food shelfs, charities, etc.) and that the simplified systems 50, 70, 100, 120 include only grocery stores 58 and restaurants 60 to depict the general benefits that can be achieved using the air-based moisture reduction 20 of the present disclosure.

As can be seen in FIGS. 2-5, the positions of the farms 56 within the agricultural region 52 and the business 58, 60 within the municipalities 54 are consistent across all four systems 50, 70, 100, 120. The only differences between the systems 50, 70, 100, and 120 are the locations of factories and other infrastructure for producing and transporting the raw food material (i.e., potatoes) from the farms 56 to factories to produce the food product (e.g., intermediately dried and cooked French fries or potato chips) and to transport the food product from the factories to the businesses 58, 60 so that the food product will eventually reach the ultimate consumer, i.e., people who will eat the food product. Each of the systems 50, 70, 100, and 120 are configured to process raw, natural food material (such as potatoes) grown on the farms 56 to produce a food product (such as frozen and/or packaged French fries or packaged potato chips) that are delivered to the businesses 58, 60. For the sake of simplicity and brevity, the rest of the description of the systems 50, 70, 100, and 120 will be limited to examples where the desired final food product is a French fry food product or a potato chip food product and where each of the farms 56 grow potatoes of the type that are to be processed to produce the desired French fry food product or potato chip food product. However, those having skill in the art will appreciate that the concepts described could be modified to incorporate other grown food materials for the production of other food products (such as the example food materials described above).

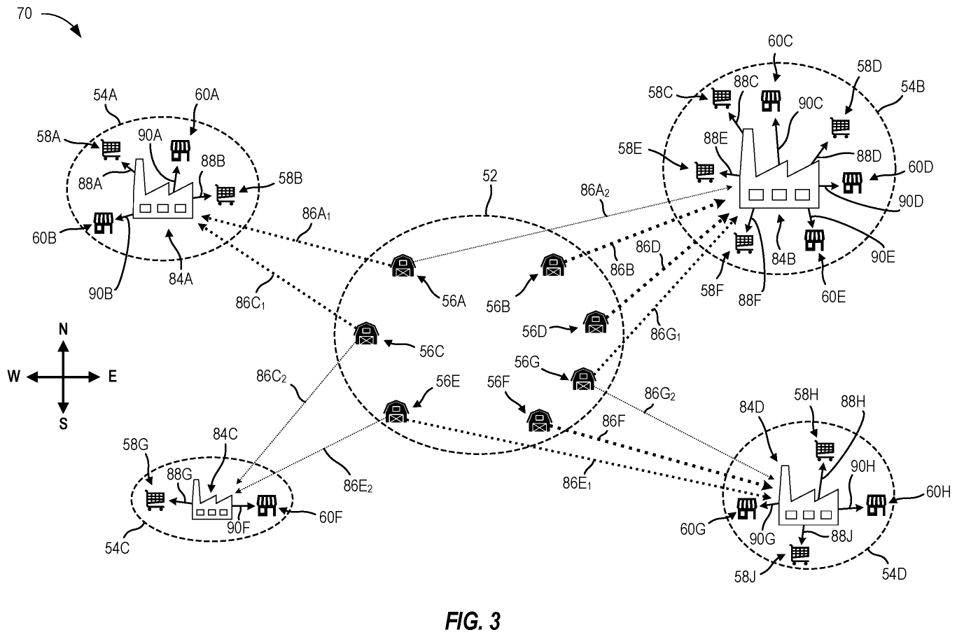

The systems 50 and 70 of FIGS. 2 and 3 are conventional arrangements for processing raw potatoes that are grown on the farms 56 to produce frozen and/or packaged French fries or potato chips that can be delivered to businesses 58, 60. In the system 50, the raw potatoes grown on each farm 56 are shipped to one or more large regional factories 72A and 72B that each supply one or more municipalities with the French fries or potato chips (also referred to generically as “regional factory 72” and/or collectively as “regional factories 72”), wherein each regional factory 72 performs all of the steps for conventional processing of raw potatoes to form packaged and/or frozen French fries or packaged potato chips. In an example, the one or more regional factories 72 are a kind of “hub” in the system 50, with each regional factory 72 being able to provide the French fries or potato chip food products to a plurality of other locations (e.g., “spokes” in the system 50″), and specifically to the various municipalities 54 for delivery to the businesses 58, 60 (described in more detail below).

In an example, the two regional factories 72A and 72B shown in FIG. 2 can be operated by competing companies or can both be operated by the same company. As noted above, in the geographic area depicted in FIG. 2, the metropolitan area 54B is the largest of the municipalities 54, and therefore both of the regional factories 72 in the system 50 of FIG. 2 are located relatively close to the metropolitan area 54B because of the largest proportion of the French fries or potato chips produced by both regional factories 72 are shipped to the metropolitan area 54B, e.g., so that the distance, and therefore the relative cost, to ship the French fries to the metropolitan area 54B can be reduced.

In the system 50, the raw potatoes that are grown on the farms 56 are shipped to the regional factories 72 via various shipping routes. The regional factories 72 then process the potatoes by conventional methods to produce a finished food product. In examples where the food product comprises French fries, the regional factory 72 can process the potatoes received from the farms 56 by cutting or shaping the potatoes into French fry-shaped potato pieces, pretreating the potato pieces with one or more enzymes and one or more cations, blanching the potato pieces, par frying the potato pieces, seasoning the French fries (which could include seasoning the cut potato pieces before par frying or seasoning the par fried potato pieces before the second frying step), and freezing and/or packaging the par fried French fries for shipping. As noted above, the final cooking step 26 of the process 10 is performed either by the end user customer himself or herself after purchasing from a grocery store 58 or other market, e.g., by baking, air frying, or oil frying at home, or is performed by a restaurant 58 or other food preparer for consumption by its customers. In examples where the food product comprises potato chips, the regional factor can process the potatoes received from the farm by slicing the potatoes into thin chip shaped slices, pretreated the potato slices with one or more enzymes and one or more cations, blanching the potato slices, frying the potato slices, seasoning the potato chips (which could be performed before or after frying the potato slices), and packaging the fried potato chips for shipping.

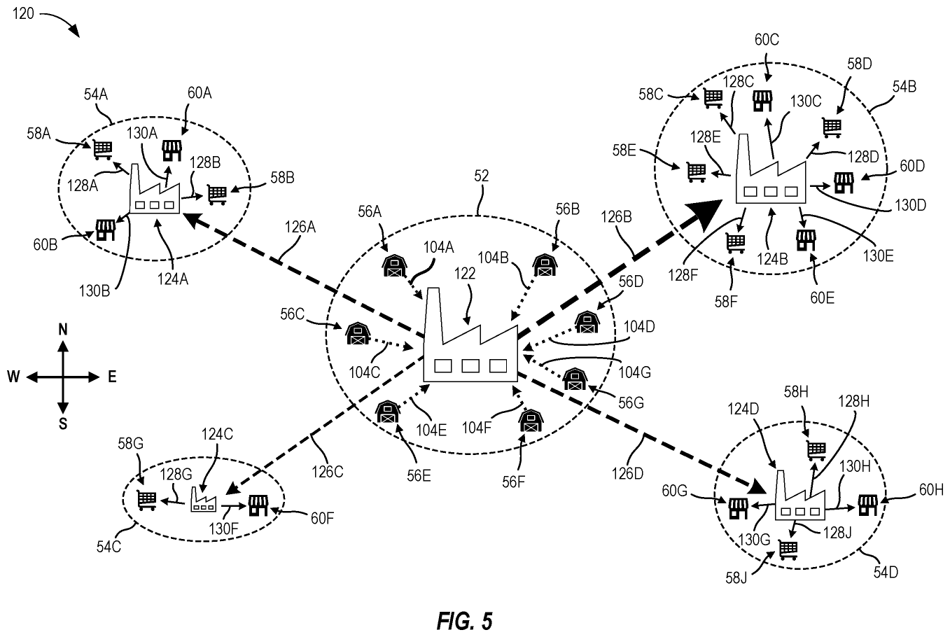

In FIGS. 2-5, shipping routes that are transporting the finished food product (e.g., the frozen par cooked French fries or the finished potato chips) are depicted as solid lines, while shipping routes that are transporting raw, natural potatoes (or intermediate potato pieces in the system 120 of FIG. 5, as described in more detail below) are depicted as dashed lines. The weight (e.g., thickness) of a particular shipping or delivery route in FIGS. 2-5 corresponds to the relative amount of material being shipped via that shipping route over a particular period of time. Heavier or thicker lines correspond to more of the material being shipped or delivered over the same time period compared to a lighter or thinner line.

Continuing with FIG. 2, the potatoes grown on the farms 56 are shipped to the regional factories 72 by one or more potato shipping routes 74A, 74B, 74C, 74D₁, 74D₂, 74E₁, 74E₂, 74F, and 74G (also referred to generically as “potato shipping route 74” and/or collectively as “potato shipping routes 74”). As shown in FIG. 2, the potato shipping routes 74 are divided between a first regional factory 72A (e.g., located to the north and slightly to the cast of the agricultural region 52 and to the west and slightly north of the metropolitan area 54B in FIG. 2) and a second regional factory 72B (e.g., located east of the agricultural region 52, south of the metropolitan area 54B, and north of the city 54D in FIG. 2). In an example, the geographic location of each farm 56 will dictate to which regional factory or factories 72 the potato shipping route or routes 74 from that particular farm 56 will ship its potatoes. For example, farms 56A, 56B, and 56C are sufficiently close to the first regional factory 72A such that it makes the most economic sense to ship all of their potatoes to the first regional factory 72A such that farms 56A, 56B, and 56C each have only one potato shipping route 74A, 74B, and 74C, respectively, each leading only to the first regional factory 72A. Similarly, farms 56F and 56G are sufficiently close to the second regional factory 72B such that each farm 56F, 56G ships all of their potatoes to the second regional factory 72B by the potato shipping routes 74F and 74G, respectively. However, farms 56D and 56E are roughly equidistant from both regional factories 72A and 72B and, therefore, it may make economic sense for farms 56D and 56E to ship to both regional factories 72, such that farm 56D may use a first potato shipping route 74D₁ to ship to the first regional factory 72A and a second potato shipping route 74D₂ to ship to the second regional factory 72B, and similarly farm 56E may use a first potato shipping route 74E₁ to ship to the first regional factory 72A and a second potato shipping route 74E₂ to ship to the second regional factory 72B.

After receiving the potatoes from the farms 56 via the potato shipping routes 74, the regional factories 72 process the potatoes by conventional methods to provide a French fry food product, e.g., as packaged and/or frozen French fries, or to provide a potato chip food product, e.g., as bagged potato chips. The packaged food products can then be shipped to the municipalities 54 by a plurality of food product shipping routes 76A, 76B₁, 76B₂, 76C, and 76D (also referred to generically as “food product shipping route 76” and/or collectively as “food product shipping routes 76”). In an example, the geographic location of each regional factory 72 will dictate to which municipalities 54 the food product shipping routes 76 from that particular regional factory 72 will ship the French fries that it produced. As mentioned above, in the convention system 50 of FIG. 2, there were economic motivations to locate the regional factories 72 close to the metropolitan area 54B because of its large population. For this reason, both regional factories 72A and 72B include food product shipping routes 76B₁ and 76B₂, respectively, to the metropolitan area 54B. For the other municipalities 54A, 54C, and 54D, the first regional factory 72A is closer to the city 54A and includes a food product shipping route 76A to the city 54A, while the second regional factory 72B is closer to the town 54C and the city 54D such that there are food product shipping routes 76C and 76D to the town 54C and the city 54D, respectively.

In an example, since the food product shipping routes 76 ship from the regional factories 72 to the municipalities 54 as a whole, in an example, the system 50 can include one or more warehouses 78A, 78B, 78C, 78D in each municipality 54 (also referred to generically as “warehouse 78” and/or collectively as “warehouses 78”) for storing the food product (frozen French fries or potato chips) until they are shipped to the businesses 58, 60. In FIG. 2, the relative size of the forklift icon for each warehouse 78 corresponds to the storage capacity of that particular warehouse 78, which generally will correspond to the size of the expected customer base of end-user customers that the warehouse 78 will service (which in turn will generally be proportional to the population for the municipality 54 where a particular warehouse 78 is located and the popularity (e.g., market share) of the French fry food product in that municipality 54). For that reason, in FIG. 2, the warehouse 78C in the town 54C is the smallest warehouse 78, the warehouse 78B in the metropolitan area 54B is the largest, and the warehouses 78A and 78D in the cities 54A and 54D are somewhere in between.

Each warehouse 78 can be configured to store the food product under specified conditions to avoid spoilage of the food product before it is time for delivery to the local businesses 58, 60. For example, if the food product received from one or more of the regional factors 72, 72 is par fried French fries, then the warehouse 78 can include large scale freezers to keep the par fried French fries frozen before delivery. In other examples where the food product is finished potato chips, then the warehouse 78 may not need specialized storage because potato chips typically can be kept at room temperature for long periods of time, although the warehouse 78 could be equipped with refrigeration or other specialized conditions to minimize degradation of the potato chips until it is time for delivery to the local businesses 78.

The warehouses 78 store the food product until it is delivered to local businesses 58, 60 in the municipality, such as via grocery delivery routes 80A, 80B, 80C, 80D, 80E, 80F, 80G, 80H, and 80J between the warehouses 78 and the grocery stores 58 (also referred to generically as “grocery delivery route 80” and/or collectively as “grocery delivery routes 80”) and restaurant delivery routes 82A, 82B, 82C, 82D, 82E, 82F, 82G, and 82H between the warehouses 78 and the restaurants 60 (also referred to generically as “restaurant delivery route 82” and/or collectively as “restaurant delivery routes 82”). Those having skill in the art will appreciate that the depiction of a separate grocery delivery route 80 for each grocery store 58 and a separate restaurant delivery route 82 for each restaurant 60 is simply for illustration, and that a plurality of the delivery routes 80 and/or 82 in a particular municipality 54 can be combined as a single delivery route or loop.

FIG. 3 shows an alternative conventional system 70 for processing raw potatoes that are grown on the farms 56 to produce a potato-based food product, such as frozen par fried French fries or potato chips, that can be delivered to the local businesses 58, 60. The primary difference between the system 50 of FIG. 2 and the system 70 of FIG. 3 is that the system 70 includes one or more factories 84A, 84B, 84C, 84D in each municipality 54 (also referred to generically as “municipal factory 84” and/or collectively as “municipal factories 84”) compared to the larger regional factories 72 in the system 50. Like the regional factories 72, each municipal factory 84 performs all of for conventional processing of raw potatoes to form the specified food product. For example, if the food product is frozen par fried French fries, then the municipal factory 84 can cut or shape the potatoes into French fry-shaped potato pieces, pretreat the potato pieces with one or more enzymes and/or one or more cations, blanch the potato pieces, par fry the potato pieces, season the French fries (which could include seasoning the cut potato pieces before par frying step or seasoning the par fried French fries after the par frying step), and freezing and/or packaging the par fried French fries for shipping. In examples where the food product is potato chips, the municipal factory 84 can slice the potatoes into thin chip-like potato slices, pretreat the potato slices with one or more enzymes and/or one or more cations, blanch the potato slices, fry the potato slices, season the potato chips (which could include seasoning the potato slices before the frying step or seasoning the fried potato chips after the frying step).

In FIG. 3, the relative size of the factory icon for each municipal factory 84 corresponds to the production capacity of that particular municipal factory 84, which generally will correspond to the size of the expected customer base of end-user customers that the municipal factory 84 will service (which in turn will generally be proportional to the population for the municipality 54 where a particular municipal factory 84 is located and the popularity (e.g., market share) of the food product in that municipality 54). For that reason, in FIG. 3, the municipal factory 84C in the town 54C is the smallest, the municipal factory 84B in the metropolitan area 54B is the largest, and the municipal factories 84A and 84D in the cities 54A and 54D are somewhere in between. As can also be seen by comparing FIGS. 2 and 3, the municipal factories 84 are each smaller than the either of the regional factories 72.

In the system 70, the raw potatoes that are grown on the farms 56 are shipped to the municipal factories 84 via various potato shipping routes 86A₁, 86A₂, 86B, 86C₁, 86C₂, 86D, 86E₁, 86E₂, 86F, 86G₁, and 86G₂ (also referred to generically as “potato shipping route 86” and/or collectively as “potato shipping routes 86”). As shown in FIG. 3, the potato shipping routes 86 are divided between the municipal factories 84. In an example, the geographic location of each farm 56 dictates to which municipal factory or factories 84 the potato shipping route or routes 86 from that particular farm 56 will ship its potatoes and on the demand for potatoes at each municipal factory 84. For example, each farm 56 may ship at least some of its potatoes to the municipal factory 84 of the municipality 54 that is closest to that farm 56. For example, farm 56A ships at least a portion of its potatoes to the municipal factory 84A in the city 54A via a potato shipping route 86A₁, farm 56B ships at least a portion of its potatoes to the municipal factory 84B in the metropolitan area 54B via the potato shipping route 86B, farm 56C ships at least a portion of its potatoes to the municipal factory 84C in the town 54C via potato shipping route 86C₂, farm 56D ships at least a portion of its potatoes to the municipal factory 84B in the metropolitan area 54B via the potato shipping route 86D, farm 56E ships at least a portion of its potatoes to the municipal factory 84C in the 54C via the potato shipping route 86E₂, farm 56F ships at least a portion of its potatoes to the municipal factory 84D in the city 54D via the potato shipping route 86F, and farm 56G ships at least a portion of its potatoes to the municipal factory 84D in the city 54D via the potato shipping route 86G₂.

The relative amount of potatoes shipped along each potato shipping route 86 may depend on more than just the relative geographic location of the farm 56 relative to the municipal factory 84 along that particular potato shipping route 86. The demand for potatoes in each municipal factory 84 may also require one or more of the farms 56 to split the potatoes grown between two or more of the municipal factories 84, which are then shipped by two or more shipping routes 86 for one or more of the farms. For some farms 56, the relative demand may not make any difference, in particular if the farm 56 is closest to a relatively large municipality 54. For example, farms 56B and 56D are sufficiently close to the metropolitan area 54B and the demand for potatoes by the municipal factory 84B in the metropolitan area 54B is sufficiently high that farms 56B and 56D ship all of their potatoes to the municipal factory 84B via only one potato shipping route 86B and 86D, respectively, per farm 56B and 56D. Similarly, farm 56F is sufficiently close to the city 54D and the demand for potatoes by the municipal factory 84D in the city 54D is sufficiently high such that there is only one potato shipping route 86F from the farm 56F to the municipal factory 84D.

However, the demand for potatoes by one or more of the municipal factories 84 can be large enough (because of the higher population within the municipality 54 where the municipal factory 84 is located) that those municipal factories 84 may need to pull additional supply from other farms 56 in order to meet their demand. For example, the population in the metropolitan area 54B may be so large that it results in a disproportional demand for the final food product, which in turn would cause the demand for potatoes by the municipal factory 84B in the metropolitan area 54B to pull supply from other farms 56 even if those other farms 56 are not particularly close to the metropolitan area 54B. For example, as shown in FIG. 3, in addition to the potato shipping routes 86B and 86D, the municipal factory 84B is supplied by a small portion of the potatoes from farm 56A by potato shipping route 86A₂ (while the remaining majority of the potatoes from farm 56A are shipped to the city 54A by shipping route 86A₁) and by a majority portion of the potatoes from the farm 56G by potato shipping route 86G₁ (while the remaining small portion of the potatoes from farm 56G are shipped to the city 54D by shipping route 86G₂).

Conversely, the demand for potatoes by one or more municipal factories 84 in a smaller municipality may not be large enough to even require all of the potatoes from the farm or farms 56 closest to that smaller municipality 54. For example, the town 54C has such a small population that the demand for potatoes by the municipal factory 84C in the town 54C is not large enough to need all of the potatoes from either farm 56C or farm 56E, which are closer to the town 54 than any of the other municipalities 54. Therefore, in an example, farm 56C ships a small portion of its potatoes to the municipal factory 84C by potato shipping route 86C₂ (while the majority of the potatoes from farm 56C are shipped to the city 54A by potato shipping route 86C₁ to help satisfy the demand from the larger municipal factory 84A) and farm 56E ships a small portion of its potatoes to the municipal factory 84C by potato shipping route 86E₂ (while the remaining majority of the potatoes from farm 56E are shipped to the city 54D by potato shipping route 86E₁ to help satisfy the demand from the larger municipal factory 84D).

After receiving the potatoes from the farms 56 via the potato shipping routes 86, the municipal factories 84 process the potatoes by conventional methods to provide the food product, e.g., as described above. The food product can then be delivered to the local businesses 58, 60 within the same municipality 54, such as via grocery delivery routes 88A, 88B, 88C, 88D, 88E, 88F, 88G, 88H, and 88J between the municipal factories 84 and the grocery stores 58 (also referred to generically as “grocery delivery route 88” and/or collectively as “grocery delivery routes 88”) and restaurant delivery routes 90A, 90B, 90C, 90D, 90E, 90F, 90G, and 90H between the municipal factories 84 and the restaurants 60 (also referred to generically as “restaurant delivery route 90” and/or collectively as “restaurant delivery routes 90”). The grocery delivery routes 88 and the restaurant delivery routes 90 can be similar or even identical to the delivery routes 80 and 82 in the system 50 of FIG. 2.

As can be seen by a comparison of the system 50 in FIG. 2 and the system 70 in FIG. 3, by processing the potatoes in one or more smaller municipal factories 84 located in each municipality 54 instead of in the larger regional factories 72, the warehouses 78 are not necessary (or are combined with the municipal factories 84), which allows the system 70 to be built with less capital expenditure required compared to the system 50. The one or more municipal factories 84 in each municipality 54 can also be more specifically tailored to the size of the market for that municipality 54, which can lead to more efficient production and delivery of the food product compared to the regional factories 72 of the system 50, which may require shipping the food product longer distances via the food product shipping routes 76.

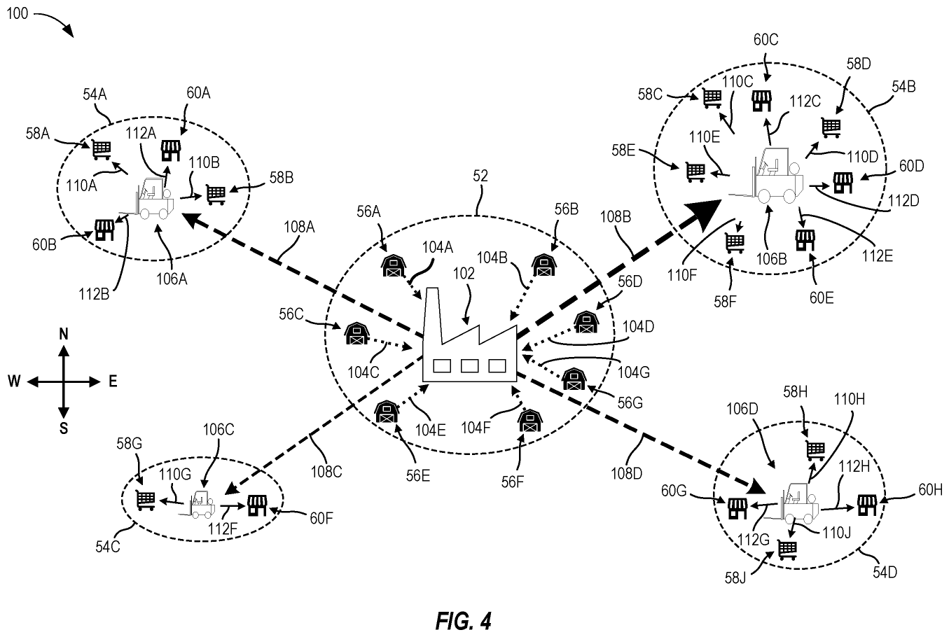

FIGS. 4 and 5 shows general schematic diagrams of example systems 100 and 120, respectively, that take advantage of the moisture reducing process described above. The specific aspects of the example system 100 shown in FIG. 4 and of the system 120 in FIG. 5 are examples of larger systems that can use the moisture reducing process described herein, and those having skill in the art will appreciate that there can be many modifications—including additions, subtractions, or substitutions compared to what is shown and described for the example systems 100 and 120 in FIGS. 4 and 5.

As mentioned above, the systems 100 and 120 can each include one or more centralized moisture-reduction facilities 102 and 122, respectively, which are also referred to herein simply as “the centralized factory 102” when discussing aspects that only occur in the system 100, “the centralized factory 122” when discussing aspects that only occur in the system 120, and “the centralized factory 102, 122” or “the centralized factories 102, 122” when discussing aspect that are common to both systems 100 and 120. The use of the term “centralized” when referring to the centralized factories 102, 122 is not meant as a literal location requirement in that the factory 102, 122 need not be in a central location relative to the other locations and facilities shown and described for the systems 100 and 120. Rather, “centralized” is being use a term of relativity, in that the centralized factories 102, 122 are a “hub” in each system 100, 120 that can provide moisture-reduced food pieces to a plurality of other locations within the system 100, 120 (e.g., the “spokes” of the system 100, 120), and specifically to facilities located in each municipality 54, which are described in more detail below.

The primary difference between the systems 100 and 120 of FIGS. 4 and 5 and the systems 50 and 70 of FIGS. 2 and 3 is that the systems 100 and 120 moves the initial processing of the potatoes, e.g., at least initial food piece shaping and the air-based moisture reduction process of the present disclosure, closer to the farms 56. At least these preliminary process steps are performed at the centralized factory 102, 122 (which can each be a singular centralized factory 102, 122 as shown in FIGS. 4 and 5 or a plurality of centralized factories 102, 122). The system 120 of FIG. 5 also splits the processing of the potatoes between two different types of facilities, i.e., the centralized factory 122 and one or more factories 124A, 124B, 124C, and 124D that perform one or more finishing processing steps (also referred to generically as “finishing factory 124” and/or collectively as “finishing factories 124), as described in more detail below.

As described in more detail below, the centralized factory 102, 122 can perform at least a portion of the steps of the overall process of making the desired final food product. For example, if the overall process of preparing the desired food product is process 10, described above, then the centralized factory 102, 122 can be configured to perform the steps of: receiving the potatoes from the farms 56 (step 12); cutting or shaping the potatoes into a plurality of potato pieces having a specified shape (such as into cylindrical shaped pieces if the final food product is French fries or thin potato slices if the final food product is potato chips, step 14); optionally pretreating the potato pieces or slices, such as with enzyme and/or cation treatment (step 16); optionally blanching the potato pieces or slices (step 18); reducing the moisture of the potato pieces or slices to a specified moisture content by the air-drying process of the present disclosure (step 20) to provide the moisture-reduced food pieces 24; optionally packaging and/or cooling the moisture-reduced food pieces 24; and transporting the moisture-reduced food pieces 24 to one or more of the municipalities 54.

As with the factories 72 and 84 in the systems 50 and 70 of FIGS. 2 and 3, the relative size of the factory icon for the centralized factory 102, 122 corresponds to the production capacity of the centralized factory 102. For example, because the centralized factory 102, 122 is designed to perform at least a portion of the processing of all of the potatoes from all of the farms 56 in the agricultural region 52, instead of just a portion of the potatoes as is the case with the regional factories 72 of the system 50 and the municipal factories 84 of the system 70, the icons for the centralized factories 102 and 122 are depicted in FIGS. 4 and 5 as being larger even than the regional factories 72 in FIG. 2. Those having skill in the art will appreciate that this does not mean that the centralized factory 102, 122 be actually physically larger than any of the regional factories 72 or municipal factories 84 might be in real life, but rather is just a conceptual depiction showing the potato processing capacity that the centralized factory 102, 122 has compared to the factories 72, 84. The size of the icons of all of the factories 72, 84, 102, and 122 also are roughly proportional to the required capital expenditure to build that particular factory 72, 84, 102, 122, although the present disclosure is not limited to a particular factory being more expensive to build than a factory that is depicted to be smaller.

In both of the systems 100 and 120 of the present disclosure, the potatoes that are grown on the farms 56 are shipped to the centralized factory 102, 122 via various potato shipping routes 104A, 104B, 104C, 104D, 104E, 104F, and 104G (also referred to generically as “potato shipping route 104” and/or collectively as “potato shipping routes 104”). In the example shown for the systems 100 and 120, the centralized factory 102, 122 is located in the same agricultural region 52 where the farms are located 56 so that the potato shipping routes 104 can be as short as possible (and thus as inexpensive as possible). In the example shown in FIGS. 4 and 5, each farm 56 has roughly the same growing capacity (e.g., each farm 56 grows roughly the same amount of potatoes during a particular period of time as each of the other farms 56 in the agricultural region 52), such that the dashed arrows that depict the potato shipping routes 104 all have the same weight (as opposed to the systems 50 and 70 where some of the farms 56 split their potato yield between the regional factories 72 and the municipal factories 84, respectively, so that the potato shipping routes 74, 86 have different weights depending on if the yield of a particular farm 56 is split and the proportion of that farm's potatoes that is going to each factory 82, 84).

After receiving the potatoes from the farms 56 via the potato shipping routes 104, the centralized factory 102, 122 performs one or more of the processing steps of the present disclosure to prepare specified food pieces, e.g., of the process 10 described above. For example, if the final food product is to be French fries, the centralized factory 102, 122 can be designed to cut or shape the potatoes into a plurality of potato pieces having a French fry shape (step 14); pretreat the potato pieces, such as with an enzyme and/or a cation treatment (step 16, optional); blanch the potato pieces (step 18, optional); reduce the moisture of the potato pieces to an intermediate moisture content by the air-drying process of the present disclosure to provide the air-dried French fries (step 20); and cool (e.g., freeze) and/or package the moisture-reduced French fries for transport. If the final food product is to be potato chips, the centralized factory 102, 122 can be designed to slice the potatoes into thin chip-like potato slices (step 14); pretreat the potato slices, such as with an enzyme and/or a cation treatment (step 16, optional); blanch the potato slices (step 18, optional); reduce the moisture of the potato slices to a desired final moisture content for potato chips by the air-drying process of the present disclosure to provide air-dried potato chips (step 20); and packaging the air-dried potato chips for transport. The centralized factory 102, 122 can also performs other steps, such as adding flavors or seasoning to the food pieces.

From this point on, the system 100 of FIG. 4 and the system 120 of FIG. 5 differ and will be described separately. As described in more detail below, the primary difference between the system 100 of FIG. 4 and the system 120 of FIG. 5 are the portion or portions of the potato processing that is performed by the centralized factories 102 and 122 versus portions of the processing that are performed at facilities within the municipalities 54 that receive the moisture-reduced food pieces from the centralized factory 102, 122.

Turning to FIG. 4, in an example, the centralized factory 102 in the system 100 performs all or substantially all of the processing steps for preparing the desired food pieces (e.g., frozen air-dried French fries or air-dried potato chips) and the food pieces prepared by the centralized factory 102 are shipped to one or more warehouses 106A, 106B, 106C, and 106D in the municipalities 54A, 54B, 54C, and 54D, respectively (also referred to generically as “warehouse 106 and/or collectively as “warehouses 106”) for storage and eventual distribution to the local businesses 58, 60. The warehouses 106 can be similar or identical to the warehouses 78 described above with respect to the system 50 of FIG. 2, except that the warehouses 106 are receiving the moisture-reduced food pieces (e.g., air dried French fries or air-dried potato chips) that had been dried by the air-based moisture reduction process of the present disclosure rather than the oil fried food pieces received from the regional factories 72. In the system 100, the moisture-reduced food pieces are shipped to the one or more warehouses 106 by a plurality of food piece shipping routes 108A, 108B, 108C, and 108D (also referred to generically as “food piece shipping route 108” and/or collectively as “food piece shipping routes 108”). As with other shipping routes described herein, the relative thickness of each particular food piece shipping route 108 is roughly proportional to the weight of moisture-reduced food pieces being shipped via that particular food piece shipping route 108 for a particular unit of time. Similarly, the size of the icons for each warehouse 106 is roughly proportional to the storage capacity of that warehouse 106 (e.g., the amount of moisture-reduced food pieces that can be stored in a particular warehouse 106 before being delivered to the local businesses 58, 60). Similar to the warehouses 78, the storage capacity that a particular warehouse 106 will be designed for generally will correspond to the size of the expected customer base of end-user customers that warehouse 106 will service (which in turn will generally be proportional to the population for the municipality 54 where the warehouse 106 is located and the popularity (e.g., market share) of the food product in that municipality 54). For that reason, in FIG. 4, the warehouse 106C in the town 54C is the smallest and the food piece shipping route 108C is the thinnest, the warehouse 106B in the metropolitan area 54B is the largest and the food piece shipping route 108B is the thickest, and the warehouses 106A and 106D in the cities 54A and 54D and the food piece shipping routes 108A and 108D are somewhere in between.

In an example, each warehouse 106 is located in a particular municipality 54, and once it is time to deliver the food pieces from the warehouse 106, the food pieces are delivered to the local businesses 58, 60, such as via grocery delivery routes 110A, 110B, 110C, 110D, 110E, 110F, 110G, 110H, and 110J between the warehouses 106 and the grocery stores 58 (also referred to generically as “grocery delivery route 110” and/or collectively as “grocery delivery routes 110”) and restaurant delivery routes 112A, 112B, 112C, 112D, 112E, 112F, 112G, and 112H between the warehouses 106 and the restaurants 60 (also referred to generically as “restaurant delivery route 112” and/or collectively as “restaurant delivery routes 112”). The grocery delivery routes 110 and the restaurant delivery routes 112 can be similar or even identical to the grocery delivery routes 80, 88 and the restaurant delivery routes 82, 90 in the systems 50 and 70.

Turning to FIG. 5, in the system 120 the centralized factory 122 does not perform all of the steps of the process that prepares the final food pieces. Rather, the centralized factory 122 performs a preliminary portion of the processing steps to prepare intermediate food pieces which are then shipped to the one or more finishing factories 124 by a plurality of intermediate food piece shipping routes 126A, 126B, 126C, and 126D (also referred to generically as “intermediate shipping route 126” and/or collectively as “intermediate shipping routes 126”). Each finishing factory 124 receives the intermediate food pieces via a corresponding intermediate shipping route 126 and performs the final portion of the processing steps on the intermediate food pieces to produce the final food pieces as they will be delivered to the local businesses 58, 60 and eventually purchased by the end user customers. The final food product that is produced by the final processing steps of the finishing factories 124 are then delivered to the local businesses 58, 60, such as via grocery delivery routes 128A, 128B, 128C, 128D, 128E, 128F, 128G, 128H, and 128J between the finishing factories 124 and the grocery stores 58 (also referred to generically as “grocery delivery route 128” and/or collectively as “grocery delivery routes 128”) and restaurant delivery routes 130A, 130B, 130C, 130D, 130E, 130F, 130G, and 130H between the finishing factories 124 and the restaurants 60 (also referred to generically as “restaurant delivery route 130” and/or collectively as “restaurant delivery routes 130”). The grocery delivery routes 128 and the restaurant delivery routes 130 can be similar or even identical to the grocery delivery routes 80, 88, 110 and the restaurant delivery routes 82, 90, 112 in the systems 50, 70, and 100.

The particular processing steps that are performed at the finishing factories 124 can vary depending on preferences of the party or company designing the system 120. For example, if the desired food product is French fries, the centralized factory 122 can receive potatoes from the farms 56 via the potato shipping routes 104, the centralized factory 122 can then wash the potatoes (optional), cut or otherwise shape the potatoes into cylindrical French fry shaped potato pieces, pretreating the potato pieces with an enzyme treatment and/or with a cation treatment, blanching the potato pieces, and then subjecting the potato pieces to the air-based moisture reduction process 20 of the present disclosure to produce intermediate air-dried potato pieces (which are cooked similarly and have a similar consistency to potato pieces that have been conventionally par fried in oil). The intermediate air-dried potato pieces can then be cooled to a storage temperature (e.g., frozen) and/or packaged for delivery to one or more of the finishing factories 124 via the intermediate shipping routes 126. In such an example, each finishing factory 124 can perform various further processing steps to convert the intermediate air-dried potato pieces to the desired final French fry product. In one example, the finishing factory 124 can season one or more groups of the intermediate air-dried potato pieces with one or more specified combinations of seasoning or flavoring to provide one or more specific product lines of French fries (e.g., a “traditional” French fry product primarily seasoned with salt, a “Cajun-style” French fry product with southern-themed spices, a “vinegar” French fry that includes vinegar flavoring in place of or in addition to other seasoning or flavoring, etc.). In another example, the air-based moisture reduction that is performed at the centralized factory 122 may only partially dry the potato pieces (e.g., the centralized factory moisture reduction process may be configured to reduce the moisture content of the intermediate potato pieces to a value that is higher than the desired moisture content for the French fry potato pieces that are ultimately shipped to the local businesses 58, 60), and the finishing factory 124 can perform additional drying to the desired final moisture content (either via the same type of air-based moisture reduction as is performed in the centralized factory 124 or via another drying process). In yet another example, the air-based moisture reduction that is performed at the centralized factory 122 can result in intermediate potato pieces that have a similar consistency to that of conventionally oil par fried French fry potatoes, and the finishing factory 124 can perform at least a partial final cooking step (e.g., at least a portion of a final oil frying step, at least a portion of a final baking step, or at least a portion of a final air frying step). The purpose of at least a partial final cooking step is that the resulting French fry product is so that the final cooking that needs to be performed (e.g., by the end user customer if purchased from a grocery store 58 or by a chef at one of the restaurants 60) can be shorter than may typically be required for the French fry product where the partial final cook is not performed at the finishing factory 124, which can reduce the cost and simplify the process of preparing cooked French fries, and can result in a slightly more efficient system 120 overall, because the larger scale final frying, final baking, final air frying, or other final cooking that takes place in the finishing factories 124 can be more efficient on a per mass of French fry basis than the small batch final frying or other final cooking performed in restaurants 60 or in an end user customer's kitchen.

In examples where the final food product is potato chips (or another snack food), the processing that is performed at the centralized factory 122 can be similar to the example described above wherein the final food product is French fries—e.g., the centralized factory 122 can receive potatoes from the farms 56, wash the potatoes (optional), peel the potatoes, slice the potatoes into thin potato chip shaped slices, pretreating the potato slices with an enzyme treatment and/or with a cation treatment, blanching the potato slices, and then subjecting the potato slices to the air-based moisture reduction process 20 of the present disclosure to reduce the moisture content of the potato pieces from the initial moisture content of the potatoes (e.g., from about 75% to about 85%, by weight, such as from about 78% to about 82%, by weight) to a final moisture content typical for potato chips (e.g., from about 1% to about 4% moisture, by weight, such as from about 1.5% to about 3.5%, by weight). The air-dried potato chips can be allowed to cool or frozen for long term storage and can be packaged for bulk transport to the finishing factories 124 via the intermediate shipping routes 126. In an example, the finishing factories 124 can season or otherwise flavor the air-dried potato chips into one or more flavor products (e.g., “traditional” potato chips with salt and/or a small amount of oil for taste, “sea salt and vinegar” potato chips, mesquite or other barbecue flavoring for barbecue style potato chips, sour cream and/or onion flavoring for sour cream and onion potato chips, etc.) similar to what was described above for various flavors of French fries. In another example, the air-based moisture reduction process of the present invention that is performed at the centralized factory 122 can partially dry the potato slices (e.g., by not drying the potato slices all the way down to the desired final moisture content of from about 1.5% to about 3.5%, by weight), and the finishing factories 124 can perform oil frying of the partially air-dried potato slices, but for a much shorter period of time than conventional oil frying of potato chips. For example, conventional oil frying of potato slices from their original potato moisture content to a final moisture content of from about 1.5% to about 3% by weight can be from about 2 minutes to about 4 minutes, or as long as 7 minutes to about 10 minutes for so-called “kettle” chips, but since the potato slices have already been partially dried by the moisture reduction process of the present disclosure in the centralized factory 122, the time for the final oil frying in the finishing factory 124 can be reduced to as little as 15 second to 30 seconds. The finishing factories 124 can also package the potato chips into various different branded packaging (e.g., the finishing factory 124 may product similar potato chips that are sold under two or more different brands) and/or various different sizes of package (e.g., snack size bags, full size bags for grocery stores, or bulk sized bags for warehouse-style stores such as Sam's Club or Costco) for delivery to the local businesses 58, 60 via the grocery delivery routes 128 and restaurant delivery routes 130.

Incorporating the air drying moisture reduction process of the present disclosure (e.g., step 20 of the process 10 described above) into the centralized factory 102, 122 as in the systems 100 and 120 can provide for several advantages over the conventional systems 50 and 70 of FIGS. 2 and 3. First, the systems 100 and 120 can more efficiently perform the more energy intensive steps of the process 10. For example, because the initial moisture reduction for the preparation of a French fry food product (i.e., wherein the air-based moisture reduction process 20 of the present disclosure replaces convention par frying in oil) or the primary moisture reduction for the preparation of a potato chip food product (i.e., where the air-based moisture reduction process 20 of the present disclosure replaces conventional oil frying of potato chips) is performed for all of the potatoes in the geographic area are performed in a common centralized factory or factories 102, 122 compared to the conventional systems 50 and 70 where the potatoes from the farms 56 are split among a plurality of regional factories 72 or municipal factories 84. This can provide for economies of scale for the air-based moisture reduction step (which can be a very energy intensive step in the process 10), wherein the larger total capacity of the centralized factory 102 can provide the same amount of moisture reduction at slightly less energy required per mass of potatoes processed compared to the smaller capacity regional factories 72 and municipal factories 84.

Second, the systems 100 and 120 can provide for more efficient shipping of materials around the geographic area, which also reduces the overall energy requirements for the transportation of material. For example, because the centralized factory 102, 122 can be located within the same agricultural region 52 as the farms 56, the average distance per mass the potatoes in the systems 100, 120 have to travel to reach the centralized factory 102, 122 is less than the average distance per mass the potatoes in the system 50 have to travel to reach the regional factories 72 or the potatoes in the system 70 have to travel to reach the municipal factories 84 (as represented by the shorter lines for the potato shipping routes 104 compared to the potato shipping routes 74 and 86. Also, in general, each of the farms 56 will usually be closer to the centralized factory 102, 122 than to any of the municipalities 54 in the geographical region, which means there usually will not be a situation where at least some of the potatoes from a particular farm 56 will be shipped to a location that is not the closest processing facility. For example, in the version of the system 50 shown in FIG. 2, farm 56D splits its potatoes between the two regional factories 72A and 72B (via potato shipping routes 74D₁ and 74D₂), as does farm 56E via potato shipping routes 74E₁ and 74E₂. Similarly, in the version of the system 70 shown in FIG. 3, farm 56A splits its potatoes between municipal factories 84A and 84B via potato shipping routes 86A₁ and 86A₂, farm 56C splits its potatoes between municipal factories 84A and 84C via potato shipping routes 86C₁ and 86C₂, farm 56E splits its potatoes between municipal factories 84C and 84D via potato shipping routes 86E₁ and 86E₂, and farm 56G splits its potatoes between municipal factories 84B and 84D (via potato shipping routes 86G₁ and 86G₂. Regardless of which regional factory 72A, 72B or municipal factory 84A, 84B, 84C, 84D that any of the farms 56A, 56C, 56D, 56E, or 56G are closest to, at least a portion of the potatoes from each of farms 56D and 56E in FIG. 2 are being shipped to a regional factory 72A, 72B that is farther away from that particular farm 56D, 56E, and at least a portion of the potatoes from each of farms 56A, 56C, 56E, and 56G are being shipped to a municipal factory 84 that is farther away from that particular farm 56A, 56C, 56E, and 56G. This results in transportation inefficiency in the conventional systems 50 and 70 that is remedied by the system 100.

Similarly, in the version of the system 50 shown in FIG. 2, the French fry output of each of the two regional factories 72 is split between multiple municipalities. For example, the first regional factory 72A ships some of its final food product to the city 54A via the food product shipping route 76A and some to the metropolitan area 54B via the food product shipping route 76B₁. The second regional factory 72B splits its output even more, shipping a first portion of its output to the metropolitan area 54B via the food product shipping route 76B2, a second portion to the town 54C via the food product shipping route 76C, and a third portion to the city 54D via the food product shipping route 76D. This also adds some inefficiency to the conventional system 50 that is remedied by the system 100.

Third, the systems 100 and 120 can also provide for less weight being shipped overall. The heaviest of any of the materials being shipped are the raw potatoes that are harvested at the farms 56. That is because when the potatoes are harvested, and while the potatoes are being shipped along the potato shipping routes 74, 86, 104, the potatoes have the highest moisture content that they will have throughout the entire process. As will be appreciated by those having skill in the art, the weight of water within the potatoes represents a high percentage of the total weight of the potatoes, and therefore the potatoes are substantially heavier, overall, than air-dried intermediate potato pieces (if the final food product is French fries) or air-dried potato chips (if the final food product is potato chips) that are yielded from those potatoes after the air-based moisture reduction process of the present disclosure is performed in the centralized factory 102, 122. And because fuel efficiency during shipping is inversely affected by the weight of the cargo being shipped, the shorter the distance the highest-moisture potatoes can travel to reach the facility that will perform moisture reduction (e.g., the regional factories 72 in the conventional system 50, the municipal factories 84 in the conventional system 70, and the centralized factories 102 and 122 in the systems 100, 120 of the present disclosure) and the sooner in the process that the moisture reduction can be performed, the lower the total shipping costs will be. Also, when conventional par frying is used as the initial moisture reduction step when the final food product is French fries or when conventional oil frying is used for moisture reduction when the final food product is potato chips (as in the factories 72 and 84 of the conventional systems 50 and 70), the oil frying also tends to replace at least some of the moisture removed from the potato pieces with oil, which results in par fried French fry pieces or conventionally fried potato chips being slightly heavier compared to the air-dried potato pieces dried by the air-based moisture reduction process of the present disclosure (where moisture is removed by evaporation and is not replaced with something else). In the systems 100 and 120, all of the heaviest, highest moisture material (i.e., the potatoes) travel a relatively short distance along the potato shipping routes 104 to the centralized factories 102, 122 compared to the potato shipping routes 74 to the regional factories 72 and the potato shipping routes 86 to the municipal factories 84 because the centralized factory 102, 122 can be located within the same agricultural region 52 as the farms 56 where the potatoes are grown, while the regional factories 72 and the municipal factories 84 are located outside of the agricultural reason. Also, because at least a portion of the moisture reduction (e.g., the air-based moisture reduction of the present disclosure) is performed close in space and time to the farms 56, the total weight being shipped along the shipping routes 108 from the centralized factory 102 to the warehouses 106 or along the shipping routes 126 from the centralized factory 122 to the finishing factories 124 will be substantially lower than the total weight being shipped along the potato shipping routes 74 to the regional factories 72 in the system 50 and the total weight being shipped along the potato shipping routes 86 to the municipal factories 84 in the system 70.

Fourth, in the case of the system 120 of FIG. 5, because each finishing factory 124 can be located in a particular municipality 54, the system 120 can allow the finishing steps of the process that are performed in the finishing factories 124 to be tailored to the specific market that it serves. For example, if each municipality 54 has slightly different taste regarding one or more properties of the food product (such as different seasoning desires, different preferred moisture content for the final French fries or the potato chips, or other properties such as color, crispness, etc.), then one or more finishing factories 124 can be located in each municipality 54 to cater to the one or more distinct tastes. In contrast, at least with the system 50, there is much less flexibility for the regional factories 72 because each regional factory 72 serves a larger percentage of the overall geographic area. Also, as shown in FIG. 5, the size of each finishing factory 124 in a particular municipality 54 can be tailored to the size of the potential market (e.g., corresponding to the population and/or popularity of the French fry food product for the municipality 54).

Finally, the system 120 where one portion of the process 10 is performed in the centralized factory 122 and another portion of the process 10 is performed in one of the finishing factories 124 can allow both types of factories 122 and 124 to be built with less complexity and less need for specialized design and system integration. For example, the centralized factory 122 may only require one primary energy intensive step (i.e., the air-based moisture reduction process of the present disclosure) that requires only one set of conditions (e.g., only air heating to a specific temperature or temperatures for one set of drying times for the different stages of the air drying process). Similarly, each finishing factory 124 is responsible for fewer steps (e.g., compared to the regional factories 72 and the municipal factories 84), and thus is in charge of fewer conditions compared to the factories 72, 84. In contrast, each of the regional factories 72 and the municipal factories 84 include both the energy intensive air-based moisture reduction step of the present disclosure, which requires one set of conditions (e.g., the par frying step requires heating oil to a first temperature and frying the potato pieces for a first period of time), and the rest of the process performed in the factories 72, 84 require additional equipment (e.g., seasoning machines, packaging machines, etc.), which have additional conditions that must be managed at the factory 72, 84. Therefore, the factories 72 and 84 require a more complex and integrated system with more complex controls and more unit operations, which results in the overall costs for designing and building the factories 72 and 84 will tend to be higher than those for designing and building the centralized factory 122 and the finishing factories 124.

### EXAMPLES

Various embodiments of the present invention can be better understood by reference to the following Examples which are offered by way of illustration. The present invention is not limited to the Examples given herein.

In the examples below, samples were analyzed for moisture using the convection oven method, e.g., by measuring the weight lost as a result of heating a ground sample (e.g., 4 grams, run in triplicate) in a convection oven under controlled conditions (e.g., heated at 100° C. for 24 hours). The percent of weight lost was reported as the percent of moisture in the sample. The convection oven moisture method was based upon the method described in R. P. Ruis, “Gravimetric Determination of Water by Drying and Weighing: Measuring Moisture Using a Convection Oven,” in Current Protocols in Food Analytical Chemistry, John Wiley and Songs, 2003, pp. A1.1.1.

In the examples below, samples were analyzed for fat content using a variation of the chloroform extraction method described by F. I. Shanii, “Extraction and Measurement of Total Lipids,” in Current Protocols in Food Analytical Chemistry, John Wiley and Sons, 2003, pp. D1.1.4. The modified fat content method included the following steps:
1) Grind the sample in a blend.
2) Prepare a 2:1 solution of chloroform:methanol.
3) Measure 10 g of the ground sample into a flask; add 50 milliliters (mL) of the 2:1 chloroform and methanol solution.
4) Stir covered for 1 hour.
5) Pour the stirred mixture into a clean flask through filter paper.
6) Rinse the initial flask and remaining solids into the new flask with a small amount of the 2:1 chloroform and methanol solution.
7) Add 30-35 mL of distilled water and mix.
8) Let sit at 4° C. overnight.
9) Remove settled top layer containing water and methanol with a water aspirator and glass pipette.
10) Weigh a new round bottom flask and record.
11) Pour the remaining solution into the new round bottom flask though a filter, pass the remaining layer of chloroform (and fat) over sodium sulfate to remove any remaining water. Wash all of the fat into the round bottom flask using additional chloroform.
12) Using a rotovap at 50° C. and 80 rpm, remove (evaporate) the remaining chloroform.
13) Place the round bottom flask in a chemical fume hood overnight to completely evaporate any remaining chloroform.
14) Weigh the round bottom flask after drying is complete, record and determine the amount of fat.

### Example 1 (⅜ Inch French Fries, Enzyme Pre-Treatment, Blanching, Air Drying, and Final Frying)

Raw Kennebec potatoes were washed, peeled, then cut into ⅜ inch strips for French Fry shape. Approximately 25 pounds (lbs.) of these potato strips were then rinsed to remove free starch and pre-treated in a solution comprising 18 kilograms (kg) water, 162 grams (g) Amylase Enzyme (SEB Amyl L, Enzyme Innovation, Chino, CA), and 108 g Calcium Chloride (32% solution, Allied Blending LB, Keokuk, IA) for three (3) minutes. The pre-treated potato strips were then blanched for 100 seconds in 180° F. water.

After blanching the potato strips were dried in a multi-zone fluidized bed air dryer. A total of 25 lbs. of pretreated, blanched potato strips were placed in the multi-zone fluidized bed dryer for a total of 20 minutes. The dryer system consisted of 2 combined dryers with six (6) total zones. Zones 1-4 were in the first dryer, and Zones 5 and 6 were in the second dryer. In Zones 1-4, the blanched potato strips were vibrated at 95% of the air dryer's maximum vibration force. In Zones 5 and 6, the potato strips were vibrated at 60% of the air dryer's maximum vibration force. In Zone 1, the air temperature was set at 400° F. and the air blowers were set at 95% of the maximum air velocity for the air dryer (estimated to be from about 13,500 ft/min to about 14,250 ft/min). In Zone 2, the air temperature was set at 395° F. and the blowers were set at 85% of the maximum air velocity (estimated to be from about 12,000 ft/min to about 12,750 ft/min). In Zone 3, the air temperature was set at 375° F. and the blowers were set at 75% of the maximum air velocity (estimated to be from about 10,500 ft/min to about 11,250 ft/min). In Zone 4, the air temperature was set at 330° F. and the blowers were set at 60% of the maximum air velocity (estimated to be from about 8,250 ft/min to about 9,000 ft/min). In Zone 5, the air temperature was set at 260° F. and the blowers were set at 25% of the maximum air velocity (estimated to be from about 3,000 ft/min to about 3,750 ft/min). In Zone 6, the air temperature was set at 250° F. and the blowers were set at 10% of the maximum air velocity (estimated to be from about 750 ft/min to about 1,500 ft/min).

A total of 13.85 lbs. of partially dried potato strips were collected. The partially dried potato strips had a measured moisture content of 48.3%, by weight. The partially dried potato strips were frozen immediately.

The frozen potato strips were subsequently removed from the freezer and fried in sunflower oil at 370° F. for 1 minute, 30 seconds. The resulting French fries had a fat content of 15.3%, by weight, and a final moisture content of 27.4%, by weight. Evaluation by sensory professionals determined samples to have an even, golden color, as crisp texture on the outside, with a fluffy white center and a pleasant fried potato flavor.

### Example 2 (⅜ Inch French Fries, Enzyme Pre-Treatment, Blanching, Oil Addition, Air Drying with Less Drying Time, and Final Frying)

Raw Kennebec potatoes were washed, peeled, then cut into ⅜ inch strips for French Fry shape. Approximately 25 lbs. of these potato strips were then rinsed to remove any free starch and pre-treated in a solution comprising 18 kg water, 162 g Amylase Enzyme (SEB Amyl L, Enzyme Innovation, Chino, CA), and 108 g Calcium Chloride (32% solution, Allied Blending LB, Keokuk, IA) for three (3) minutes. The pre-treated potato strips were then blanched for 100 seconds in 180° F. water.

After blanching the potato strips were coated with 500 g of sunflower oil and dried in the same first multi-zone fluidized bed dryer as in EXAMPLE 1. A total of 25 lbs. of the pretreated, blanched potato strips coated in oil were placed in the multi-zone fluidized bed dryer for a total of 7 minutes. The dryer system included a single dryer with four (4) separate heating zones. All four zones were vibrated at 95% of the air dryer's maximum vibration force. In Zone 1, the air temperature was set at 400° F. and the air blowers were set at 95% of the maximum air velocity for the air dryer (estimated to be from about 13,500 ft/min to about 14,250 ft/min). In Zone 2, the air temperature was set at 400° F. and the blowers were set at 90% of the maximum air velocity (estimated to be from about 12,750 ft/min to about 13,500 ft/min). In Zone 3, the air temperature was set at 375° F. and the blowers were set at 75% of the maximum air velocity (estimated to be from about 10,500 ft/min to about 11,250 ft/min). In Zone 4, the air temperature was set at 330° F. and the blowers were set at 60% of the maximum air velocity (estimated to be from about 8,250 ft/min to about 9,000 ft/min).

A total of 14.95 lbs. of the partially dried potato strips were collected. The partially dried potato strips had a measured moisture content of 59.4%, by weight. These partially dried potato strips were frozen immediately.

The frozen potato strips were subsequently removed from the freezer and fried in sunflower oil at 370° F. for 1 minute, 30 seconds. The resulting French fries had a fat content of 10.7%, by weight, and a final moisture content of 35.6%, by weight. Evaluation by sensory professionals determined samples to have an even, golden color, as crisp texture on the outside, with a fluffy white center and a pleasant fried potato flavor. The French fry product was found to have stayed crispy even after cooling for 12-14 minutes.

### Example 3 (¼ Inch French Fries, Enzyme Pre-Treatment, Blanching, Air Drying, and Final Frying)

Raw Kennebec potatoes were washed, peeled, then cut into ¼ inch strips for a “shoestring” French Fry shape. Approximately 25 lbs. of these potato strips were then rinsed to remove any free starch and pre-treated in a solution comprising 18 kg water, 162 g Amylase Enzyme (SEB Amyl L, Enzyme Innovation, Chino, CA), and 108 g Calcium Chloride (32% solution, Allied Blending LB, Keokuk, IA) for three (3) minutes. The pre-treated potato strips were then blanched for 80 seconds in 180° F. water.

After blanching the potato strips were dried in the same multi-zone fluidized bed air dryer as in EXAMPLE 2. A total of 25 lbs. of pretreated, blanched potato strips were placed in the multi-zone fluidized bed dryer for a total of 5.25 minutes. The dryer system included a single dryer with four (4) separate heating zones. All four zones were vibrated at 95% of the air dryer's maximum vibration force. In Zone 1, the air temperature was set at 400° F. and the air blowers were set at 95% of the maximum air velocity for the air dryer (estimated to be from about 13,500 ft/min to about 14,250 ft/min). In Zone 2, the air temperature was set at 380° F. and the blowers were set at 90% of the maximum air velocity (estimated to be from about 12,750 ft/min to about 13,500 ft/min). In Zone 3, the air temperature was set at 360° F. and the blowers were set at 75% of the maximum air velocity (estimated to be from about 10,500 ft/min to about 11,250 ft/min). And in Zone 4, the air temperature was set at 330° F. and the blowers were set at 60% of the maximum air velocity (estimated to be from about 8,250 ft/min to about 9,000 ft/min).

A total of 13.45 lbs. of the partially dried potato strips were collected. The partially dried potato strips had a measured moisture content of 49.4%, by weight. These partially dried potato strips were frozen immediately.

The frozen potato strips were subsequently removed from the freezer and fried in sunflower oil at 370° F. for 1 minute, 30 seconds. The resulting shoestring French fries had a fat content of 15.7%, by weight, and a final moisture content of 18.4%, by weight. Evaluation by sensory professionals determined samples to have an even, golden color, as crisp texture on the outside, with a fluffy white center and a pleasant fried potato flavor.

### Example 4 (⅜ Inch French Fries, Enzyme Pre-Treatment, Blanching, Oil Addition, Air Drying, and Final Frying)

Raw Kennebec potatoes were washed, peeled, then cut into ⅜ inch strips for French Fry shape. Approximately 25 lbs. of these potato strips were then rinsed to remove any free starch and pre-treated in a solution comprising 18 kg water, 162 g Amylase Enzyme (SEB Amyl L, Enzyme Innovation, Chino, CA), and 108 g Calcium Chloride (32% solution, Allied Blending LB, Keokuk, IA) for three (3) minutes. The pre-treated potato strips were then blanched for 100 seconds in 180° F. water.

After blanching, the potato strips were coated with approximately 0.45%, by weight, of sunflower oil and then dried in the same multi-zone fluidized bed dryer as in EXAMPLES 2 and 3. A total of 25 lbs. of the pretreated, blanched potato strips coated with sunflower oil were placed in the multi-zone fluidized bed dryer for a total of 5.25 minutes. The dryer system included a single dryer with four (4) separate heating zones. All four zones were vibrated at 95% of the air dryer's maximum vibration force. In Zone 1, the air temperature was set at 400° F. and the air blowers were set at 95% of the maximum air velocity for the air dryer (estimated to be from about 13,500 ft/min to about 14,250 ft/min). In Zone 2, the air temperature was set at 380° F. and the blowers were set at 90% of the maximum air velocity (estimated to be from about 12,750 ft/min to about 13,500 ft/min). In Zone 3, the air temperature was set at 360° F. and the blowers were set at 75% of the maximum air velocity (estimated to be from about 10,500 ft/min to about 11,250 ft/min). In Zone 4, the air temperature was set at 330° F. and the blowers were set at 60% of the maximum air velocity (estimated to be from about 8,250 ft/min to about 9,000 ft/min).

A total of 13.25 lbs. of the resulting partially dried potato strips were collected. The moisture of the partially dried potato strips were 51.3%, by weight. These strips were frozen immediately.

The frozen potato strips were subsequently removed from the freezer and fried in sunflower oil at 370° F. for 1 minute, 30 seconds. The resulting French fries had a fat content of 19.3%, by weight, and a final moisture content of 18.0%, by weight. Evaluation by sensory professionals determined samples to have an even, golden color, as crisp texture on the outside, with a fluffy white center and a pleasant fried potato flavor. The French fry product retained a crispy texture even after cooling for 10-12 minutes.

### Example 5 (⅜ Inch French Fries, Enzyme Pre-Treatment, Blanching, Air Drying with Less Drying Time, Final Baking)

Raw Kennebec potatoes were washed, peeled, then cut into ⅜ inch strips for French Fry shape. Approximately 25 lbs. of these potato strips were then rinsed to remove any free starch and pre-treated in a solution comprising 18 kg water, 162 g Amylase Enzyme (SEB Amyl L, Enzyme Innovation, Chino, CA), and 108 g Calcium Chloride (32% solution, Allied Blending LB, Keokuk, IA) for three (3) minutes. The pre-treated potato strips were then blanched for 100 seconds in 180° F. water.

After blanching, the potato strips were dried in the same multi-zone fluidized bed air dryer as in EXAMPLES 2-4. A total of 25 lbs. of the pretreated, blanched potato strips were placed in the multi-zone fluidized bed dryer for a total of 8 minutes. The dryer system included a single dryer with four (4) separate heating zones. All four zones were vibrated at 95% of the air dryer's maximum vibration force. In Zone 1, the air temperature was set at 400° F. and the air blowers were set at 95% of the maximum air velocity for the air dryer (estimated to be from about 13,500 ft/min to about 14,250 ft/min). In Zone 2, the air temperature was set at 400° F. and the blowers were set at 90% of the maximum air velocity (estimated to be from about 12,750 ft/min to about 13,500 ft/min). In Zone 3, the air temperature was set at 375° F. and the blowers were set at 75% of the maximum air velocity (estimated to be from about 10,500 ft/min to about 11,250 ft/min). In Zone 4, the air temperature was set at 330° F. and the blowers were set at 60% of the maximum air velocity (estimated to be from about 8,250 ft/min to about 9,000 ft/min).

A total of 13.52 lbs. of the resulting partially dried potato strips were collected. The partially dried potato strips had a moisture content of 56.7%, by weight. The partially dried potato strips were frozen immediately.

The frozen potato strips were subsequently removed from the freezer and coated with 7.5% sunflower oil, by weight, and were then stored back in the freezer. Instead of frying, the oil coated potato strips were baked in a conventional oven for 12 minutes at 400° F. The finished baked French fry product had a fat content of 7.80%, by weight, and a final moisture content of 38.8%, by weight. Evaluation by sensory professionals determined samples to have an even, golden color, as crisp texture on the outside, with a fluffy white center and a pleasant fried potato flavor without deep frying in oil.

### Example 6 (⅜ Inch French Fries, Enzyme Pre-Treatment, Blanching, Oil Addition, Air Drying with Less Drying Time, Stored at Refrigeration Temperature)

Raw Russet potatoes were washed, peeled, then cut into ⅜ inch strips for French Fry shape. Approximately 25 lbs. of these potato strips were then rinsed to remove any free starch and pre-treated in a solution comprising 18 kg water, 162 g Amylase Enzyme (SEB Amyl L, Enzyme Innovation, Chino, CA), and 108 g Calcium Chloride (32% solution, Allied Blending LB, Keokuk, IA) for three (3) minutes. The pre-treated potato strips were then blanched for 100 seconds in 180° F. water.

After blanching, the potato strips coated with approximately 500 g sunflower oil before drying in the same multi-zone fluidized bed dryer as in EXAMPLES 2-5. A total of 25 lbs. of the pretreated, blanched, and oiled potato strips were placed in the multi-zone fluidized bed dryer for a total of 6 minutes. The dryer system included a single dryer with four (4) separate heating zones. All four zones were vibrated at 95% of the air dryer's maximum vibration force. In Zone 1, the air temperature was set at 400° F. and the air blowers were set at 95% of the maximum air velocity for the air dryer (estimated to be from about 13,500 ft/min to about 14,250 ft/min). In Zone 2, the air temperature was set at 380° F. and the blowers were set at 90% of the maximum air velocity (estimated to be from about 12,750 ft/min to about 13,500 ft/min). In Zone 3, the air temperature was set at 360° F. and the blowers were set at 75% of the maximum air velocity (estimated to be from about 10,500 ft/min to about 11,250 ft/min). And in Zone 4, the air temperature was set at 330° F. and the blowers were set at 60% of the maximum air velocity (estimated to be from about 8,250 ft/min to about 9,000 ft/min).

A total of 13.44 lbs. of the partially dried potato strips were collected. The partially dried potato strips have a moisture content of 60.3%, by weight. Approximately 10 lbs. of these partially dried potato strips were stored at refrigeration temperature in bags that were gas flushed with nitrogen to leave only 4% O₂.

Approximately half of the refrigerated dried potato strips were baked in a conventional oven for 7.5 minutes at 424° F. The resulting baked French fry products had a fat content of 6.4%, by weight and a final moisture content of 41%, by weight. Evaluation by sensory professionals determined samples to have an even, golden color, as crisp texture on the outside, with a fluffy white center and a pleasant fried potato flavor without deep frying in oil.

The other half of the refrigerated dried potato strips were fried for 1 minute at 375° F. in sunflower oil. The resulting French fries had a fat content about 13.2%, by weight, and a moisture content of 32.3%, by weight. Evaluation by sensory professionals determined samples to have an even, golden color, with a crispy texture on the outside, at a relatively lower fat content. The fried food pieces were compared to frozen French fries purchased at a grocery store of the same cut size that were fried as directions indicated (i.e., for 4 minutes at 375° F.), which resulted in limp fries containing approximately 18.0% fat and 36% moisture.

### Example 7 (⅜ Inch French Fries, Enzyme Pre-Treatment, Blanching, Air Drying, Freezing for Transport, and Final Frying)

Raw Russet potatoes were washed, peeled, then cut into ⅜ inch strips for French Fry shape. Approximately 20 lbs. of these potato strips were then rinsed to remove any free starch and pre-treated in a solution comprising 18 kg water, 162 g Amylase Enzyme (SEB Amyl L, Enzyme Innovation, Chino, CA), and 108 g Calcium Chloride (32% solution, Allied Blending LB, Keokuk, IA) for three (3) minutes. The pre-treated potato strips were then blanched for 180 seconds in 185° F. water.

After blanching, the potato strips coated with approximately 500 g sunflower oil before drying in the same multi-zone fluidized bed dryer as in EXAMPLES 2-6. A total of 20 lbs. of the pretreated, blanched, and oiled potato strips were placed in the multi-zone fluidized bed dryer for a total of 8 minutes. The dryer system included a single dryer with four (4) separate heating zones. All four zones were vibrated at 95% of the air dryer's maximum vibration force. In Zone 1, the air temperature was set at 400° F. and the air blowers were set at 95% of the maximum air velocity for the air dryer (estimated to be from about 13,500 ft/min to about 14,250 ft/min). In Zone 2, the air temperature was set at 385° F. and the blowers were set at 95% of the maximum air velocity (estimated to be from about 13,500 ft/min to about 14,250 ft/min). In Zone 3, the air temperature was set at 360° F. and the blowers were set at 75% of the maximum air velocity (estimated to be from about 10,500 ft/min to about 11,250 ft/min). And in Zone 4, the air temperature was set at 350° F. and the blowers were set at 50% of the maximum air velocity (estimated to be from about 8,000 ft/min to about 8,500 ft/min).

A total of 10.25 lbs. of the partially dried potato strips were collected, bagged and frozen. The partially dried potato strips have a moisture content of 59.22%, by weight, with approximately 8.93% fat.

Two weeks later, the frozen potato strips were fried for 1 minute at 365° F. in sunflower oil. The resulting French fries had a fat content about 13.4%, by weight, and a moisture content of 37.6%, by weight. Evaluation by sensory professionals determined samples to have an even, golden color, with a crispy texture on the outside, at a relatively lower fat content. The fried food pieces were compared to frozen French fries purchased at a grocery store of the same cut size that were fried as directions indicated (i.e., for 4 minutes at 365° F.), which resulted in limp fries containing approximately 18.2.0% fat and 39.3% moisture.

### Example 8 (Potato Chips, 0.065 Inch Potato Slices, Enzyme Pre-Treatment, Blanching, Air Drying, Freezing for Transport, and Final Frying)

Raw Lamoka variety potatoes were washed, sliced using an Urschel Model CC Slicer into 0.065 inch (1.65 mm) slices typical for potato chip processing. Approximately 20 lbs. of these potato slices were then rinsed to remove any free starch and pre-treated in a solution comprising 18 kg water, 162 g Amylase Enzyme (SEB Amyl L, Enzyme Innovation, Chino, CA), and 108 g Calcium Chloride (32% solution, Allied Blending LB, Keokuk, IA) for three (3) minutes. The pre-treated potato slices were then blanched for 80 seconds in 180° F. water.

After blanching, the 20 lbs. of pre-treated, blanched potato strips were coated with approximately 488 g. sunflower oil before drying in a multi-zone fluidized bed dryer for a total of 6.5 minutes. The dryer system included a single dryer with four (4) separate heating zones. All four zones were vibrated at 80% of the air dryer's maximum vibration force. In Zone 1, the air temperature was set at 400° F. and the air blowers were set at 95% of the maximum air velocity for the air dryer (estimated to be from about 13,500 ft/min to about 14,250 ft/min). In Zone 2, the air temperature was set at 400° F. and the blowers were set at 90% of the maximum air velocity (estimated to be from about 13,000 ft/min to about 13,750 ft/min). In Zone 3, the air temperature was set at 360° F. and the blowers were set at 75% of the maximum air velocity (estimated to be from about 10,500 ft/min to about 11,250 ft/min). And in Zone 4, the air temperature was set at 360° F. and the blowers were set at 50% of the maximum air velocity (estimated to be from about 8,000 ft/min to about 8,500 ft/min).

A total of 7.85 lbs. of the partially dried potato slices were collected, bagged and frozen. The partially dried potato slices have a moisture content of 13.15%, by weight, with approximately 11.76% fat.

Two weeks later, the frozen potato slices were fried for 25 seconds at 350° F. in sunflower oil. The resulting Potato Chips had a fat content about 22.14%, by weight, and a moisture content of 2.09%, by weight. Evaluation by sensory professionals determined samples to have an even, golden color, with a crispy texture, at a relatively lower fat content than conventional potato chips that are deep fried.

### Example 9 (Snack Food, ¼ Inch Cut Potato Sticks, Enzyme Pre-Treatment, Blanching, Air Drying, Freezing for Transport, and Final Frying)

Raw Lamoka variety potatoes were washed, peeled, then cut into ¼ inch strips for French Fry shape. Approximately 20 lbs. of these potato strips were then rinsed to remove any free starch and pre-treated in a solution comprising 18 kg water, 162 g Amylase Enzyme (SEB Amyl L, Enzyme Innovation, Chino, CA), and 108 g Calcium Chloride (32% solution, Allied Blending LB, Keokuk, IA) for three (3) minutes. The pre-treated potato strips were then blanched for 180 seconds in 185° F. water.

After blanching, the potato strips coated with approximately 500 g sunflower oil before drying in the same multi-zone fluidized bed dryer. A total of 20 lbs. of the pretreated, blanched, and oiled potato strips were placed in the multi-zone fluidized bed dryer for a total of 6.5 minutes. The dryer system included a single dryer with four (4) separate heating zones. All four zones were vibrated at 80% of the air dryer's maximum vibration force. In Zone 1, the air temperature was set at 400° F. and the air blowers were set at 95% of the maximum air velocity for the air dryer (estimated to be from about 13,500 ft/min to about 14,250 ft/min). In Zone 2, the air temperature was set at 385° F. and the blowers were set at 95% of the maximum air velocity (estimated to be from about 13,500 ft/min to about 14,250 ft/min). In Zone 3, the air temperature was set at 360° F. and the blowers were set at 75% of the maximum air velocity (estimated to be from about 10,500 ft/min to about 11,250 ft/min). And in Zone 4, the air temperature was set at 350° F. and the blowers were set at 50% of the maximum air velocity (estimated to be from about 8,000 ft/min to about 8,500 ft/min).

A total of 8.95 lbs. of the partially dried potato strips were collected, bagged and frozen. The partially dried potato strips have a moisture content of 10.33%, by weight, with approximately 10.96% fat.

Two weeks later, the frozen potato strips were fried for 45 seconds at 360° F. in sunflower oil. The resulting Crunchy Snack had a fat content about 24.25%, by weight, and a moisture content of 1.99%, by weight. Evaluation by sensory professionals determined samples to have an even, golden color, with a crispy texture, at a relatively lower fat content than conventional fried shoestring potato snacks.

### Example 10 (Potato Chips, 0.065 Inch Cut Potato Slices, Enzyme Pre-Treatment, Blanching, Air Drying to Less than 15% Moisture then Final Flash Frying to Finish

Raw Lamoka variety potatoes were washed, sliced using an Urschel Model CC Slicer into 0.065 inch (1.65 mm) slices typical for potato chip processing. Approximately 20 lbs. of these potato slices were then rinsed to remove any free starch and pre-treated in a solution comprising 18 kg water, 162 g Amylase Enzyme (SEB Amyl L, Enzyme Innovation, Chino, CA), and 108 g Calcium Chloride (32% solution, Allied Blending LB, Keokuk, IA) for three (3) minutes. The pre-treated potato slices were then blanched for 75 seconds in 175° F. water.

After blanching, the 20 lbs. of pre-treated, blanched potato strips were dried in a multi-zone fluidized bed dryer for a total of 7.5 minutes. The dryer system included a single dryer with four (4) separate heating zones. All four zones were vibrated at 80% of the air dryer's maximum vibration force. In Zone 1, the air temperature was set at 395° F. and the air blowers were set at 90% of the maximum air velocity for the air dryer (estimated to be from about 13,000 ft/min to about 14,000 ft/min). In Zone 2, the air temperature was set at 390° F. and the blowers were set at 85% of the maximum air velocity (estimated to be from about 12,500 ft/min to about 13,250 ft/min). In Zone 3, the air temperature was set at 360° F. and the blowers were set at 75% of the maximum air velocity (estimated to be from about 10,500 ft/min to about 11,250 ft/min). And in Zone 4, the air temperature was set at 340° F. and the blowers were set at 50% of the maximum air velocity (estimated to be from about 8,000 ft/min to about 8,500 ft/min).

A total of 8.25 lbs. of the partially dried potato slices were collected. The partially dried potato slices have a moisture content of 14.15%, by weight.

From the collected partially dried potato slices, approximately 250 g. potato slices were immediately fried for 25 seconds at 350° F. in sunflower oil. The resulting Potato Chips had a fat content about 26.24%, by weight, and a moisture content of 2.34%, by weight. Evaluation by sensory professionals determined samples to have an even, golden color, with a crispy texture, at a relatively lower fat content than conventional potato chips that are deep fried.

### Example 11 (Snack Food, ¼ Inch Cut Potato Sticks, Enzyme Pre-Treatment, Blanching, Applying Small Amount of Oil, then Air Drying, with Final Flash Frying)

Raw Lamoka variety potatoes were washed, peeled, then cut into 0.25 inch strips for French Fry shape. Approximately 25 lbs. of these potato strips were then rinsed to remove any free starch and pre-treated in a solution comprising 18 kg water, 162 g Amylase Enzyme (SEB Amyl L, Enzyme Innovation, Chino, CA), and 108 g Calcium Chloride (32% solution, Allied Blending LB, Keokuk, IA) for three (3) minutes. The pre-treated potato strips were then blanched for 130 seconds in 180° F. water.

After blanching, the potato strips coated with approximately 300 g sunflower oil before drying in the same multi-zone fluidized bed dryer. A total of 25 lbs. of the pretreated, blanched, and oiled potato strips were placed in the multi-zone fluidized bed dryer for a total of 8.5 minutes. The dryer system included a single dryer with four (4) separate heating zones. All four zones were vibrated at 80% of the air dryer's maximum vibration force. In Zone 1, the air temperature was set at 400° F. and the air blowers were set at 95% of the maximum air velocity for the air dryer (estimated to be from about 13,500 ft/min to about 14,250 ft/min). In Zone 2, the air temperature was set at 385° F. and the blowers were set at 95% of the maximum air velocity (estimated to be from about 13,500 ft/min to about 14,250 ft/min). In Zone 3, the air temperature was set at 360° F. and the blowers were set at 75% of the maximum air velocity (estimated to be from about 10,500 ft/min to about 11,250 ft/min). And in Zone 4, the air temperature was set at 350° F. and the blowers were set at 50% of the maximum air velocity (estimated to be from about 8,000 ft/min to about 8,500 ft/min).

A total of 18 lbs. of the partially dried potato strips were collected, the partially dried potato strips have a moisture content of 15.50%, by weight, with approximately 0.25% fat.

Immediately approximately 250 g. of the potato strips were fried for 30 seconds at 350° F. in sunflower oil. The resulting Crunchy Snack had a fat content about 20.25%, by weight, and a moisture content of 2.82%, by weight. Evaluation by sensory professionals determined samples to have an even, golden color, with a crispy texture, at a relatively lower fat content than conventional fried shoestring potato sticks.

### Additional Embodiments

To better illustrate the air-based moisture reduction of the present disclosure and the food pieces that result therefrom, a non-limiting list of EMBODIMENTS is provided herein:

EMBODIMENT 1 can include a prepared food product comprising a plurality of food pieces comprising a food material, the food pieces having a reduced overall moisture content, wherein the moisture content of the food pieces was not reduced by oil or fat frying.

EMBODIMENT 2 can include a prepared food product comprising a plurality of food pieces having a reduced overall moisture content, and wherein the food pieces are free or substantially free of fried oil.

EMBODIMENT 3 can include the subject matter of one or any combination of EMBODIMENT 1 or EMBODIMENT 2, wherein the food pieces have no added fat content compared to a naturally-occurring fat content of the food material.

EMBODIMENT 4 can include the subject matter of one or any combination of EMBODIMENTS 1-3, wherein the reduced overall moisture content is less than a naturally-occurring moisture content for the food material.

EMBODIMENT 5 can include the subject matter of one or any combination of EMBODIMENTS 1-4, wherein the food material comprises vegetable material or fruit material.

EMBODIMENT 6 can include the subject matter of one or any combination of EMBODIMENTS 1-5, wherein the food material comprise at least one of: potato, sweet potato, yam, green bean, beet, pumpkin, squash, tomato, mushroom, zucchini, carrot, eggplant, okra, onion, parsnip, rutabaga, taro, yuca, cassava, apple, pear, banana, pineapple, plantain, papaya, mango, nut, legume, bean, and seed.

EMBODIMENT 7 can include the subject matter of one or any combination of EMBODIMENTS 1-6, wherein the food pieces have a size in a smallest dimension of at least about 5 millimeters.

EMBODIMENT 8 can include the subject matter of EMBODIMENT 7, wherein the food pieces comprise sticks having a length in a first direction, a width in a second direction, and a depth in a third direction, wherein the length is larger than the width and the depth, and wherein the width and the depth are at least about 5 millimeters.

EMBODIMENT 9 can include the subject matter of one or any combination of EMBODIMENTS 1-8, wherein the food pieces have a size in a smallest dimension of at least about 9 millimeters.

EMBODIMENT 10 can include the subject matter of EMBODIMENT 9, wherein the food pieces comprise sticks having a length in a first direction, a width in a second direction, and a depth in a third direction, wherein the length is larger than the width and the depth, and wherein the width and the depth are at least about 9 millimeters.

EMBODIMENT 11 can include the subject matter of one or any combination of EMBODIMENTS 7-10, wherein the reduced overall moisture content is from about 40% to about 95%, by weight.

EMBODIMENT 12 can include the subject matter of one or any combination of EMBODIMENTS 7-11, wherein the reduced overall moisture content is from about 40% to about 65%, by weight.

EMBODIMENT 13 can include the subject matter of one or any combination of EMBODIMENTS 1-6, wherein the food pieces are thin slices having a thickness of no more than about 5 millimeters.

EMBODIMENT 14 can include the subject matter of claim 13, wherein the thickness of the thin slices is no more than about 3.5 millimeters.

EMBODIMENT 15 can include the subject matter of claim 13, wherein the thickness of the thin slices is no more than about 1.6 millimeters.

EMBODIMENT 16 can include the subject matter of one or any combination of EMBODIMENTS 13-15, wherein the reduced overall moisture content is from about 5% to about 25%, by weight.

EMBODIMENT 17 can include the subject matter of one or any combination of EMBODIMENTS 13-16, wherein the reduced overall moisture content is from about 10% to about 15%, by weight.

EMBODIMENT 18 can include the subject matter of one or any combination of EMBODIMENTS 1-17, wherein a fat content of the food pieces is no more than about 30%, by weight.

EMBODIMENT 19 can include the subject matter of one or any combination of EMBODIMENTS 1-18, wherein a fat content of the food pieces is no more than about 20%, by weight.

EMBODIMENT 20 can include the subject matter of one or any combination of EMBODIMENTS 1-19, wherein a fat content of the food pieces is no more than about 15%, by weight.

EMBODIMENT 21 can include the subject matter of one or any combination of EMBODIMENTS 1-20, wherein a fat content of the food pieces is no more than about 10%, by weight.

EMBODIMENT 22 can include the subject matter of one or any combination of EMBODIMENTS 1-21, further comprising added salt.

EMBODIMENT 23 can include the subject matter of one or any combination of EMBODIMENTS 1-22, further comprising added seasoning.

EMBODIMENT 24 can include the subject matter of one or any combination of EMBODIMENTS 1-23, wherein the food pieces are packaged.

EMBODIMENT 25 can include the subject matter of one or any combination of EMBODIMENTS 1-24, wherein the food material comprises vegetable material and wherein the food pieces comprise a snack food.

EMBODIMENT 26 can include the subject matter of EMBODIMENT 25, wherein the food material comprises potato or sweet potato, or both, and wherein the snack food comprises potato chips, sweet potato chips, potato sticks, or sweet potato sticks.

EMBODIMENT 27 can include a cooked food product comprising the prepared food product of one or more of EMBODIMENTS 1-26 after being subjected to a final cooking to provided cooked food pieces.

EMBODIMENT 28 can include the subject matter of EMBODIMENT 27, wherein the final cooking comprises at least one of frying and baking.

EMBODIMENT 29 can include the subject matter of EMBODIMENT 27 or EMBODIMENT 28, wherein the food material comprises potato or sweet potato, or both, and the cooked food product comprises French fries or hashbrowns.

EMBODIMENT 30 can include the subject matter of one or any combination of EMBODIMENTS 27-29, wherein the food pieces are frozen before the final cooking.

EMBODIMENT 31 can include the subject matter of one or any combination of EMBODIMENTS 27-30, wherein the cooked food pieces are consumed within a short time after the final cooking.

EMBODIMENT 32 can be a process for preparing a food product, the process comprising providing or receiving a plurality of food pieces of a food material having an initial moisture content, optionally enzyme treating the food pieces with an effective amount of at least one starch-degrading enzyme to provide enzyme-treated food pieces, optionally blanching the enzyme-treated food pieces to deactivate the starch-degrading enzyme to provide blanched food pieces, and reducing moisture of the food pieces via air drying from the initial moisture content to a reduced overall moisture content that is lower than the initial moisture content, to provide moisture-reduced food pieces.

EMBODIMENT 33 can include the subject matter of EMBODIMENT 32, further comprising: cooling the moisture-reduced food pieces.

EMBODIMENT 34 can include the subject matter of EMBODIMENT 33, wherein the cooling of the moisture-reduced food pieces comprises refrigerating the moisture-reduced food pieces to a temperature below 40° F.

EMBODIMENT 35 can include the subject matter of one or both of EMBODIMENT 33 and EMBODIMENT 34, wherein the cooling of the moisture-reduced food pieces comprises freezing the moisture-reduced food pieces to a temperature below 32° F.

EMBODIMENT 36 can include the subject matter of one or any combination of EMBODIMENTS 32-35, wherein the reducing moisture of the food pieces does not comprise oil frying the food pieces.

EMBODIMENT 37 can include the subject matter of one or any combination of EMBODIMENTS 32-36, wherein the air drying comprises heating the food pieces in an oven or drier and flowing air over or past the food pieces.

EMBODIMENT 38 can include the subject matter of EMBODIMENT 37, wherein the air drying comprises heating the food pieces in two or more stages, wherein the two or more stages comprises a first stage heating of the food at a first air temperature and with a first air flow velocity for a first time period and a second stage heating following the first stage heating, wherein the second stage heating comprises heating the food pieces at a second air temperature and with a second air flow velocity for a second time period.

EMBODIMENT 39 can include the subject matter of EMBODIMENT 38, wherein the first air temperature is higher than the second air temperature.

EMBODIMENT 40 can include the subject matter of one or both of EMBODIMENT 38 and EMBODIMENT 39, wherein the first air flow velocity is faster than the second air flow velocity.

EMBODIMENT 41 can include the subject matter of one or any combination of EMBODIMENTS 38-40, wherein the first air temperature is from about 390° F. to about 415° F.

EMBODIMENT 42 can include the subject matter of one or any combination of EMBODIMENTS 38-41, wherein the first time period is from about 30 seconds to about 5 minutes.

EMBODIMENT 43 can include the subject matter of one or any combination of EMBODIMENTS 38-42, wherein the second air temperature is from about 385° F. to about 405° F.

EMBODIMENT 44 can include the subject matter of one or any combination of EMBODIMENTS 38-43, wherein the second time period is from about 30 seconds to about 5 minutes.

EMBODIMENT 45 can include the subject matter of one or any combination of EMBODIMENTS 38-44, wherein the two or more stages further comprises a third stage heating following the second stage heating, wherein the third stage heating comprises heating the food pieces at a third air temperature and with a third air flow velocity for a third time period.

EMBODIMENT 46 can include the subject matter of EMBODIMENT 45, wherein the second air temperature is higher than the third air temperature.

EMBODIMENT 47 can include the subject matter of one or both of EMBODIMENT 45 and EMBODIMENT 46, wherein the second air flow velocity is faster than the third air flow velocity.

EMBODIMENT 48 can include the subject matter of one or any combination of EMBODIMENTS 45-47, wherein the third air temperature is from about 370° F. to about 390° F.

EMBODIMENT 49 can include the subject matter of one or any combination of EMBODIMENTS 45-48, wherein the third time period is from about 30 seconds to about 5 minutes.

EMBODIMENT 50 can include the subject matter of one or any combination of EMBODIMENTS 45-49, wherein the two or more stages further comprises a fourth stage heating following the third stage heating, wherein the fourth stage heating comprises heating the food pieces at a fourth air temperature and with a fourth air flow velocity for a fourth time period.

EMBODIMENT 51 can include the subject matter of EMBODIMENT 50, wherein the third air temperature is higher than the fourth air temperature.

EMBODIMENT 52 can include the subject matter of one or both of EMBODIMENT 50 and EMBODIMENT 51, wherein the third air flow velocity is faster than the fourth air flow velocity.

EMBODIMENT 53 can include the subject matter of one or any combination of EMBODIMENTS 50-52, wherein the fourth air temperature is from about 315° F. to about 360° F.

EMBODIMENT 54 can include the subject matter of one or any combination of EMBODIMENTS 50-53, wherein the fourth time period is from about 30 seconds to about 5 minutes.

EMBODIMENT 55 can include the subject matter of one or any combination of EMBODIMENTS 32-54, wherein the air drying further comprises agitating the food pieces while heating the food pieces and flowing the air over or past the food pieces.

EMBODIMENT 56 can include the subject matter of one or any combination of EMBODIMENTS 32-55, further comprising cooking the moisture-reduced food pieces to a final moisture content that is less than the reduced overall moisture content, to provide cooked food pieces.

EMBODIMENT 57 can include the subject matter of EMBODIMENT 56, wherein cooking the moisture-reduced food pieces comprises frying the moisture-reduced food pieces.

EMBODIMENT 58 can include the subject matter of one or both of EMBODIMENT 56 and EMBODIMENT 57, wherein cooking the moisture-reduced food pieces comprises baking the moisture-reduced food pieces.

EMBODIMENT 59 can include the subject matter of one or any combination of EMBODIMENTS 56-58, wherein the final moisture content of the cooked food pieces is from about 1% to about 40%, by weight.

EMBODIMENT 60 can include the subject matter of one or any combination of EMBODIMENTS 56-59, wherein the final moisture content of the cooked food pieces is from about 1% to about 5%, by weight.

EMBODIMENT 61 can include the subject matter of EMBODIMENT 60, wherein the final moisture content of the cooked food pieces is from about 1% to about 3%, by weight.

EMBODIMENT 62 can include the subject matter of EMBODIMENT 60, wherein the final moisture content of the cooked food pieces is from about 15% to about 40%, by weight.

EMBODIMENT 63 can include the subject matter of one or any combination of EMBODIMENTS 56-59, wherein the final moisture content of the cooked food pieces is from about 20% to about 40%, by weight.

EMBODIMENT 64 can include the subject matter of EMBODIMENT 63, wherein the final moisture content of the cooked food pieces is from about 25% to about 40%, by weight.

EMBODIMENT 65 can include the subject matter of one or any combination of EMBODIMENTS 56-64, further comprising adding salt to the cooked food pieces.

EMBODIMENT 66 can include the subject matter of one or any combination of EMBODIMENTS 56-65, further comprising adding seasoning to the cooked food pieces.

EMBODIMENT 67 can include the subject matter of one or any combination of EMBODIMENTS 56-66, further comprising packaging the cooked food pieces.

EMBODIMENT 68 can include the subject matter of one or any combination of EMBODIMENTS 32-67, wherein the food pieces have a size in a smallest dimension of at least about 5 millimeters.

EMBODIMENT 69 can include the subject matter of one or any combination of EMBODIMENTS 32-68, wherein the food pieces have a size in the smallest dimension of at least about 9 millimeters.

EMBODIMENT 70 can include the subject matter of one or both of EMBODIMENT 68 and EMBODIMENT 69, wherein the reduced overall moisture content of the moisture-reduced food pieces is from about 40% to about 95%, by weight.

EMBODIMENT 71 can include the subject matter of one or any combination of EMBODIMENTS 68-70, wherein the reduced overall moisture content of the moisture-reduced food pieces is from about 40% to about 65%, by weight.

EMBODIMENT 72 can include the subject matter of one or any combination of EMBODIMENTS 32-67, wherein the food pieces are thin slices having a thickness of no more than about 5 millimeters.

EMBODIMENT 73 can include the subject matter of EMBODIMENT 72, wherein the thickness of the thin slices is no more than about 3.5 millimeters.

EMBODIMENT 74 can include the subject matter of one or both of EMBODIMENT 72 and EMBODIMENT 73, wherein the thickness of the thin slices is no more than about 1.6 millimeters.

EMBODIMENT 75 can include the subject matter of one or any combination of EMBODIMENTS 72-74, wherein the reduced overall moisture content of the moisture-reduced food pieces is from about 5% to about 25%, by weight.

EMBODIMENT 76 can include the subject matter of one or any combination of EMBODIMENTS 72-45, wherein the reduced overall moisture content of the moisture-reduced food pieces is from about 10% to about 15%, by weight.

EMBODIMENT 77 can include the subject matter of one or any combination of EMBODIMENTS 32-76, wherein a fat content of the moisture-reduced food pieces is no more than about 30%, by weight.

EMBODIMENT 78 can include the subject matter of one or any combination of EMBODIMENTS 32-77, wherein a fat content of the moisture-reduced food pieces is no more than about 20%, by weight.

EMBODIMENT 79 can include the subject matter of one or any combination of EMBODIMENTS 32-78, wherein a fat content of the moisture-reduced food pieces is no more than about 15%, by weight.

EMBODIMENT 80 can include the subject matter of one or any combination of EMBODIMENTS 32-79, wherein a fat content of the moisture-reduced food pieces is no more than about 10%, by weight.

EMBODIMENT 81 can include the subject matter of one or any combination of EMBODIMENTS 32-80, further comprising adding salt to the moisture-reduced food pieces.

EMBODIMENT 82 can include the subject matter of one or any combination of EMBODIMENTS 32-81, further comprising adding seasoning to the moisture-reduced food pieces.

EMBODIMENT 83 can include the subject matter of one or any combination of EMBODIMENTS 32-82, further comprising packaging the moisture-reduced food pieces.

EMBODIMENT 84 can include the subject matter of one or any combination of EMBODIMENTS 32-83, further comprising adding salt to the food pieces before the reducing of the moisture of the food pieces via the air drying.

EMBODIMENT 85 can include the subject matter of one or any combination of EMBODIMENTS 32-84, further comprising adding seasoning to the food pieces before the reducing of the moisture of the food pieces via the air drying.

EMBODIMENT 86 can include the subject matter of one or any combination of EMBODIMENTS 32-85, further comprising cutting or shaping the food material to form the food pieces before enzyme treating the food pieces.

EMBODIMENT 87 can include the subject matter of one or any combination of EMBODIMENTS 32-86, wherein the food material comprises one or both of a vegetable material and a fruit material.

EMBODIMENT 88 can include the subject matter of one or any combination of EMBODIMENTS 32-87, wherein the cut or shaped food pieces comprise at least one of: potato, sweet potato, yam, green bean, beet, pumpkin, squash, tomato, mushroom, zucchini, carrot, eggplant, okra, onion, parsnip, rutabaga, taro, yuca, cassava, apple, pear, banana, pineapple, plantain, papaya, mango, nut, legume, bean, and seed.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A prepared food product comprising:
a plurality of food pieces comprising a food material, the food pieces having a reduced overall moisture content;
wherein the moisture content of the food pieces was not reduced by oil or fat frying.

2. The prepared food product of claim 1, wherein the food pieces have no added fat content compared to a naturally-occurring fat content of the food material.

3. The prepared food product of claim 1, wherein the food material comprise at least one of: potato, sweet potato, yam, green bean, beet, pumpkin, squash, tomato, mushroom, zucchini, carrot, eggplant, okra, onion, parsnip, rutabaga, taro, yuca, cassava, apple, pear, banana, pineapple, plantain, papaya, mango, nut, legume, bean, and seed.

4. The prepared food product of claim 1, wherein the food pieces have a size in a smallest dimension of at least about 5 millimeters and wherein the reduced overall moisture content is from about 40% to about 95%, by weight.

5. The prepared food product of claim 1, wherein the food pieces are thin slices having a thickness of no more than about 3.5 millimeters and the reduced overall moisture content is from about 5% to about 25%, by weight.

6. A process for preparing a food product, the process comprising:
(a) providing or receiving a plurality of food pieces of a food material having an initial moisture content;
(b) optionally enzyme treating the food pieces with an effective amount of at least one starch-degrading enzyme to provide enzyme-treated food pieces;
(c) optionally blanching the enzyme-treated food pieces to deactivate the starch-degrading enzyme to provide blanched food pieces; and
(d) reducing moisture of the food pieces via air drying from the initial moisture content to a reduced overall moisture content that is lower than the initial moisture content, to provide moisture-reduced food pieces.

7. The process of claim 6, further comprising: (e) cooling the moisture-reduced food pieces to a temperature below 40° F.

8. The process of claim 6, wherein the reducing moisture of step (d) does not comprise oil frying the food pieces.

9. The process of claim 6, wherein the air drying comprises heating the food pieces while flowing air over or past the food pieces.

10. The process of claim 9, wherein the air drying comprises heating the food pieces in two or more stages, wherein the two or more stages comprises a first stage heating of the blanched food at a first air temperature and with a first air flow velocity for a first time period and a second stage heating following the first stage heating, wherein the second stage heating comprises heating the food pieces at a second air temperature and with a second air flow velocity for a second time period.

11. The process of claim 10, wherein the first air temperature is from about 390° F. to about 415° F. and the second air temperature is from about 385° F. to about 405° F.

12. The process claim 10, wherein the two or more stages further comprises a third stage heating following the second stage heating and a fourth stage heating following the third stage heating, wherein the third stage heating comprises heating the food pieces at a third air temperature and with a third air flow velocity for a third time period, and wherein the fourth stage heating comprises heating the food pieces at a fourth air temperature and with a fourth air flow velocity for a fourth time period.

13. The process of claim 12, wherein the third air temperature is from about 370° F. to about 390° F. and the fourth air temperature is from about 315° F. to about 360° F.

14. The process of claim 9, wherein the air drying comprises agitating the food pieces while heating the food pieces and flowing the air over or past the food pieces.

15. The process of claim 6, further comprising: (f) cooking the moisture-reduced food pieces to a final moisture content that is less than the reduced overall moisture content, to provide cooked food pieces.

16. The process of claim 15, wherein the final moisture content of the cooked food pieces is from about 15% to about 40%, by weight.

17. The process of claim 6, wherein the food pieces have a size in a smallest dimension of at least about 5 millimeters.

18. The process of claim 17, wherein the reduced overall moisture content of the moisture-reduced food pieces is from about 40% to about 95%, by weight.

19. The process of claim 6, wherein the food pieces are thin slices having a thickness of no more than about 3.5 millimeters.

20. The process of claim 19, wherein the reduced overall moisture content of the moisture-reduced food pieces is from about 5% to about 25%, by weight.

21. The process of claim 6, wherein the cut or shaped food pieces comprise at least one of: potato, sweet potato, yam, green bean, beet, pumpkin, squash, tomato, mushroom, zucchini, carrot, eggplant, okra, onion, parsnip, rutabaga, taro, yuca, cassava apple, pear, banana, pineapple, plantain, papaya, mango, nut, legume, bean, and seed.
